(19) United States
(12) Patent Application Publication
(10) Pub. No.: US 2026/0278936 A1
(43) Pub. Date: Sep. 17, 2026

(54) SYSTEM

(71) Applicant: SoftBank Group Corp., Tokyo (JP)

(72) Inventor: Masato KANAMORI, Tokyo (JP)

(73) Assignee: SoftBank Group Corp., Tokyo (JP)

(21) Appl. No.: 19/551,646

(22) Filed: Feb. 27, 2026

Related U.S. Application Data
(60) Provisional application No. 63/769,952, filed on Mar. 11, 2025.

(51) Int. Cl. G06T 17/20; G06F 40/40; G06Q 10/0833; G06T 15/10; G06T 19/20

(52) U.S. Cl. CPC G06T 17/20; G06F 40/40; G06Q 10/0833; G06T 15/10; G06T 19/20; G06T 2200/24; G06T 2219/2016

(57) ABSTRACT

A system includes a processor that is configured to receive, via an input unit, a prompt input by a consumer; generate, via a three-dimensional (3D) modeling unit, a 3D preview based on the prompt; perform, via a design unit, a detailed design based on the 3D preview; plan, via a process planning unit, a manufacturing process based on the detailed design; control, via a manufacturing unit, manufacturing of a product according to the manufacturing process; and control, via a delivery unit, delivery of the manufactured product to the consumer.

### CROSS-REFERENCE TO RELATED APPLICATION

This application claims the benefit of U.S. Provisional Application No. 63/769,952 filed on Mar. 11, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional product customization and manufacturing systems require a high degree of manual intervention at each stage, from capturing a consumer's requirements through design, process planning, manufacturing, and delivery. In many cases, consumers can only select from limited predefined options, and they cannot accurately visualize the final appearance or structure of a customized product before manufacturing begins. As a result, mismatches frequently occur between a consumer's expectations and the manufactured product, leading to reduced satisfaction, increased returns, and additional redesign or rework costs. Further, traditional systems often separate front-end specification input, design, process planning, and manufacturing execution into isolated processes and software tools. Human operators must repeatedly interpret and transfer information between these stages, which introduces delays, human errors, and inconsistencies in the transmitted specifications. These inefficiencies hinder the realization of on-demand, made-to-order production with short lead times. In addition, known systems do not sufficiently leverage interactive three-dimensional (3D) previews that are tightly integrated with downstream design and manufacturing processes. Even when 3D previews are provided, they are frequently static or loosely coupled with the actual manufacturing data, so that modifications made by consumers are not automatically propagated into detailed design drawings, production line layouts, or real-time manufacturing control. Consequently, there is a need for a system that seamlessly links consumer input, interactive 3D visualization, automatic detailed design, optimized process planning, and adaptive manufacturing and delivery management in an integrated and automated manner.

### SUMMARY

In order to solve the above-described problems, an embodiment of the present invention provides a system comprising a processor configured to coordinate an input unit, a three-dimensional (3D) modeling unit, a design unit, a process planning unit, a manufacturing unit, and a delivery unit as recited in the claims. The processor is configured to receive, via the input unit, a prompt or specifications input by a consumer, and to provide a user-friendly interface that accepts at least a shape, a color, and a material of a product. Based on the consumer's input, the processor controls the 3D modeling unit to generate a real-time, interactive 3D preview of the product. The consumer is allowed to review the 3D preview and iteratively modify the specifications, while the processor updates the 3D preview accordingly, thereby enabling the consumer to accurately understand the external appearance and configuration of the product before manufacturing. When the consumer confirms the specifications, the processor controls the design unit to perform detailed design based on the final 3D preview. In particular, the design unit uses computer-aided design (CAD) software to generate detailed design drawings that take into account an internal structure and functional elements of the product. These design drawings, together with associated design data, are then supplied to the process planning unit. The processor further controls the process planning unit to automatically plan a manufacturing process based on the detailed design. The process planning unit generates an optimal layout of a manufacturing line so as to maximize manufacturing efficiency, for example by selecting suitable machines and determining their arrangement and operating sequence. The planned manufacturing process, including scheduling and resource allocation information, is then transmitted to the manufacturing unit. The processor controls the manufacturing unit to execute the manufacturing process in accordance with the plan. The manufacturing unit manufactures the product according to the detailed design while the processor monitors manufacturing conditions in real time and adjusts the conditions as needed, for example in response to machine status, quality feedback, or detected bottlenecks. Upon completion of manufacturing, the processor controls the delivery unit to manage packaging and shipment of the manufactured product to the consumer, and to provide delivery status information to the consumer.

By tightly integrating consumer input, real-time interactive 3D preview generation, CAD-based detailed design, automatic process planning, real-time manufacturing control, and delivery management through the processor, the system according to the present invention enables efficient, accurate, and highly customized product manufacturing, thereby addressing the problems of conventional systems.

The term “processor” refers to one or more hardware computing elements, such as a CPU, GPU, microcontroller, programmable logic device, or a combination thereof, that execute instructions to implement the functions attributed to the processor in the present disclosure. The term “input unit” refers to a hardware and/or software component configured to receive information from a consumer, including but not limited to textual input, touch input, voice input, or image input, and to supply corresponding data to the processor. The term “prompt” refers to information input by a consumer in natural language or structured form, expressing requirements, preferences, or specifications for a product to be designed and manufactured by the system. The term “specifications” refers to structured data representing one or more attributes of a product requested by the consumer, including but not limited to shape, color, material, size, function, and use case. The term “user-friendly interface” refers to a graphical, voice-based, or mixed-modality interface designed to allow a consumer to input prompts and specifications in an intuitive, easy-to-understand, and interactive manner without requiring specialized technical knowledge. The term “three-dimensional (3D) modeling unit” refers to a hardware and/or software component configured to generate and update three-dimensional geometric and visual representations of a product based on consumer inputs and design data. The term “3D preview” refers to an interactive three-dimensional representation of a product that can be displayed to a consumer and manipulated, for example by rotation, zooming, or material changes, to visually confirm the product's appearance before manufacturing. The term “interactive 3D preview” refers to a 3D preview that can be updated in real time or near real time in response to changes in consumer specifications and that allows consumer interaction such as rotation, panning, and zooming. The term “design unit” refers to a hardware and/or software component configured to generate detailed product designs, including drawings and models, based on a 3D preview and consumer specifications. The term “computer-aided design (CAD) software” refers to software tools used to create, edit, and manage detailed two-dimensional or three-dimensional representations of a product, including its internal structure and functional elements. The term “detailed design drawings” refers to two-dimensional or three-dimensional design data, including dimensions, tolerances, material assignments, and structural features, sufficient to support manufacturing and assembly of the product. The term “internal structure” refers to the non-visible or partially visible components, layers, reinforcements, and geometric features inside a product that contribute to its mechanical strength, durability, or functionality. The term “functional elements” refers to specific structural or mechanical features of a product that provide defined functions, such as cushioning zones, hinges, joints, ventilation openings, or attachment points. The term “process planning unit” refers to a hardware and/or software component configured to generate a manufacturing process plan, including selection and arrangement of machines, process steps, and schedules, based on detailed design data. The term “manufacturing process” refers to a sequence of operations, including cutting, forming, molding, assembling, finishing, and inspecting, that are performed to transform raw materials and components into a finished product. The term “layout of a manufacturing line” refers to the spatial and logical arrangement of manufacturing resources, including machines, workstations, conveyors, and storage areas, along with their operational sequence for producing a product. The term “manufacturing unit” refers to one or more machines, production systems, and associated control components that execute manufacturing operations on materials and components according to the manufacturing process. The term “manufacturing conditions” refers to operating parameters and states in a manufacturing environment, including but not limited to temperature, pressure, speed, machine status, quality metrics, and resource utilization. The term “delivery unit” refers to a hardware and/or software component configured to manage packaging, shipment, and tracking of manufactured products, and to interface with logistics systems to deliver products to consumers. The term “consumer” refers to an end user or customer who interacts with the system to specify, preview, order, and receive a customized product. The term “product” refers to any physical item that is designed, manufactured, and delivered by the system in response to consumer prompts and specifications, including but not limited to footwear, apparel, bags, and furniture.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

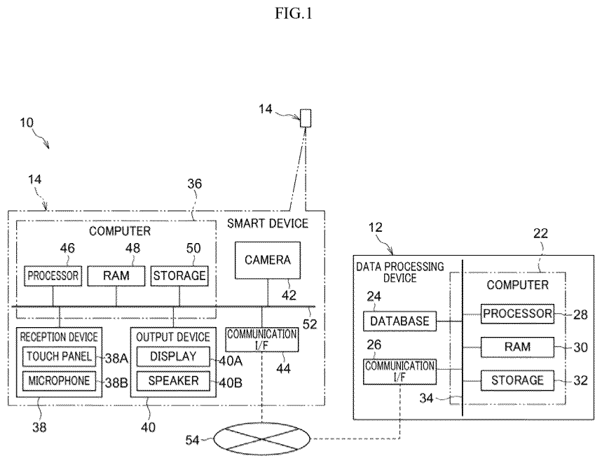

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

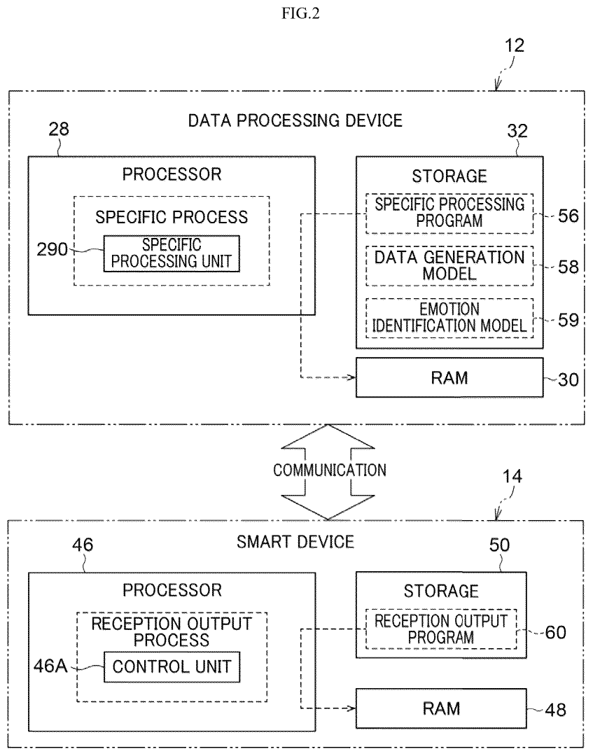

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems for configuring custom products and generating manufacturing data suffer from several technical limitations in how they acquire, interpret, and process user intent, and in how they propagate that intent through three-dimensional visualization, design generation, and process planning. First, known configuration systems typically rely on rigid form-based input and pre-defined option sets. Such systems require a user to manually fill every parameter field and cannot robustly accept natural-language prompts. As a result, the systems cannot effectively utilize prompt sentences to automatically infer missing design parameters or functional requirements. This leads to repetitive client-server interactions, increased data entry operations, and inefficient use of processor and network resources, because the server must request additional details from the terminal or reject incomplete specifications. Second, even when natural-language input is accepted, conventional systems perform only shallow keyword extraction and mapping. The interpretation pipeline is not integrated with downstream three-dimensional modeling, design software, or process-planning modules at a data-structure level. Therefore, inferred or corrected parameters from any natural-language processing are not consistently reflected in the three-dimensional preview, computer-aided design (CAD) data, and manufacturing plans. This fragmented processing requires multiple, loosely coupled subsystems and manual intervention, increasing memory usage, duplication of data transformations, and latency in generating updated previews and plans. Third, existing three-dimensional preview systems often operate separately from the design and manufacturing pipeline. A three-dimensional preview engine may generate a visualization from high-level options, while a distinct CAD automation script separately builds the manufacturing model from a different parameter set. Divergence between visualization parameters and design parameters can cause mismatches between the displayed product and the manufactured product. Moreover, when the user modifies a specification during interactive preview, conventional architectures do not provide an efficient mechanism to consistently propagate these updates to the CAD and process-planning modules with minimal recomputation. Fourth, traditional process-planning systems typically receive static design data and do not dynamically synchronize with ongoing user-driven specification changes and inferred parameters generated by artificial intelligence models. As a result, when user intent or design constraints evolve through iterative prompt sentences and preview interactions, process schedules and work instructions must be recomputed manually or via batch processes, leading to outdated production plans, underutilization of production equipment, and increased end-to-end latency from design to manufacturing. Accordingly, there is a need for a computer-implemented system that technically improves the way processors (i) receive and structure prompt sentences and multimodal specification data from a terminal, (ii) invoke a generative AI model in-line as part of the core data pipeline to infer missing or optimized parameters, (iii) generate and update three-dimensional display data in coordination with extended specification data, (iv) automatically control design software to generate detailed CAD data and component configurations from the same extended specification data, and (v) generate and dynamically update process planning data and work instructions based on production feedback, so that user intent expressed in prompt sentences is coherently and efficiently propagated from input through visualization to manufacturing and delivery in a unified processing flow. Such a system should reduce redundant data transformations, lower the number of client-server round trips, improve consistency between visual previews and manufactured products, and provide a technically improved utilization of processing, memory, and network resources in computer-based product configuration and manufacturing control.

The specific processing by the specific processing unit 290 of the data processing device 12 in Example 1 is realized by the following means.

The present invention provides a server comprising a processor configured to acquire, from a terminal operated by a user, a prompt sentence and other specification information representing at least a product category, a shape, a color, a dimension, a material, and a functional requirement, convert the prompt sentence and the other specification information into structured specification data, invoke a generative AI model using the prompt sentence and the structured specification data as input, infer, based on an output of the generative AI model, at least one missing item or recommended parameter included in the specification of a product, and integrate the inferred item or parameter into the structured specification data to generate extended specification data, generate, based on the extended specification data, three-dimensional shape data and material data, generate three-dimensional display data that is updatable in response to a change of a viewpoint with respect to the three-dimensional shape data, transmit the three-dimensional display data to the terminal, receive, from the terminal, an instruction for modifying the specification information, and, in response to the instruction, update the structured specification data and re-generate the three-dimensional display data to provide an interactive three-dimensional preview to the user, control design software based on the extended specification data and the three-dimensional shape data to automatically generate design data including detailed shape and dimension parameters and a component configuration including a list of components required for manufacturing the product, generate, based on the design data and the component configuration, process planning data including a selection of a type of production equipment and an order of processes, generate work instruction data and a process schedule, dynamically update the process schedule based on production progress information received from a production facility, control, based on the work instruction data, at least one piece of production equipment to perform machining, assembly, and finishing of materials so as to manufacture the product, and generate, based on completion information of the product, delivery information including at least a delivery route, a delivery means, and tracking information, and provide the delivery information to the terminal. This enables a unified and technically improved end-to-end processing pipeline in which the same extended specification data derived from prompt sentences is consistently utilized across natural-language interpretation, three-dimensional preview rendering, automatic design data generation, and dynamic process planning, thereby reducing redundant data transformations, lowering latency for updating previews and plans in response to user interactions, improving consistency between displayed and manufactured products, and enhancing overall efficiency of computer-based product configuration and manufacturing control.

The term “processor” refers to one or more hardware processing units, such as central processing units, graphics processing units, or other programmable logic devices, configured to execute instructions and perform arithmetic, logical, and control operations required to implement the functions described herein. The term “terminal” refers to any user-operated electronic apparatus, such as a mobile device, a tablet device, a desktop device, or a wearable device, that includes at least a display device and an input device and is configured to transmit and receive data to and from the server. The term “user” refers to a human operator who interacts with the terminal to input product specifications, prompt sentences, and modification instructions, and who receives three-dimensional previews and delivery information. The term “prompt sentence” refers to a natural-language expression, including a word, a phrase, or a sentence, input by the user and describing at least a desired product, a characteristic, or a functional requirement, and used as input to a generative AI model and to the processor for interpretation of user intent. The term “specification information” refers to data representing characteristics of a product, including at least a product category, a shape, a color, a dimension, a material, and a functional requirement, whether such data is obtained from structured user input, from a prompt sentence, or from inference by a generative AI model. The term “structured specification data” refers to specification information represented in a predefined data structure, such as a record, an object, or a table, in which each product characteristic is mapped to a corresponding field, identifier, or parameter that is directly usable by the processor, the generative AI model, a three-dimensional engine, or design software. The term “extended specification data” refers to structured specification data that has been supplemented or modified with at least one inferred item or recommended parameter generated based on an output of a generative AI model, and that is used as a common data source for three-dimensional generation, design generation, and process planning. The term “generative AI model” refers to a machine-learned computational model, such as a neural network model or a large language model, trained on data to generate outputs including at least text, numerical values, or structured data, in response to an input that includes a prompt sentence and, optionally, additional context. The term “three-dimensional shape data” refers to data representing a three-dimensional geometry of a product, including at least vertices, edges, faces, meshes, or parametric surfaces, and configured to be used by a three-dimensional rendering engine or design software. The term “material data” refers to data representing visual and physical characteristics of a material applied to a three-dimensional shape, including at least color, texture, reflectivity, roughness, transparency, and other attributes used for rendering or for design of the product. The term “three-dimensional display data” refers to data configured to be used for displaying a three-dimensional representation of a product on a display device, including at least three-dimensional shape data, material data, and viewpoint information, and capable of being updated in response to changes in viewpoint or specification. The term “interactive three-dimensional preview” refers to a process in which three-dimensional display data of a product is presented to the user and dynamically updated in response to user operations, such as rotation, zooming, or specification modification, to visually reflect changes to the product in substantially real time. The term “design software” refers to a computer-aided design application or system, including parametric modeling software or drafting software, that is configured to generate, modify, or store design data representing detailed shapes and dimensions of a product and its components. The term “design data” refers to data generated by design software, including at least geometric and dimensional definitions, structural elements, tolerances, and relationships between components of a product, suitable for use in manufacturing planning and execution. The term “component configuration” refers to data representing a set of components required to manufacture a product, including at least a list of component identifiers, quantities, materials, and optionally positions or relationships among components. The term “process planning data” refers to data representing at least a selection of a type of production equipment, an order of processes, and associated parameters, used to define how a product is to be manufactured in a production facility. The term “work instruction data” refers to data representing specific operations to be performed by production equipment or operators, including at least machine identifiers, tools, process parameters, and execution sequences, derived from process planning data and design data. The term “process schedule” refers to temporal data representing planned start times, end times, and ordering of production operations or work instructions for one or more products in a production facility. The term “production equipment” refers to one or more machines or devices used in a manufacturing process, including at least machining apparatuses, forming apparatuses, joining apparatuses, assembly apparatuses, or finishing apparatuses, which are controllable based on work instruction data. The term “production facility” refers to a physical or virtual environment in which production equipment is installed and in which manufacturing operations for products are executed, and from which production progress information can be obtained. The term “production progress information” refers to data indicating at least a state, a completion time, or an execution status of a manufacturing operation, obtained from the production facility and used to monitor or update a process schedule. The term “completion information” refers to data indicating that a product has completed manufacturing operations, including at least a completion time, an identifier of the product, and optionally quality-related information. The term “delivery information” refers to data used to perform and track delivery of a manufactured product to the user or another destination, including at least a delivery route, a delivery means, tracking information, and optionally an estimated delivery time. The term “delivery route” refers to data representing a planned path, sequence of locations, or segments used to transport a product from a production facility or warehouse to a destination. The term “delivery means” refers to a mode of transportation used for delivery of a product, including at least ground transport, air transport, sea transport, or a combination thereof. The term “tracking information” refers to data used to monitor and display a current location, status, or history of a shipped product, including at least a tracking identifier and event records from one or more delivery services or logistics systems.

In one embodiment, a server, a terminal, and one or more production devices cooperate to implement the claimed system. The server includes at least one hardware processor, main memory, non-volatile storage, and a network interface. The terminal includes at least one hardware processor, a touch-sensitive display, a microphone, a camera, and a wireless or wired communication interface. The production devices include numerically controlled machines such as cutting machines, forming machines, joining machines, assembly machines, and finishing machines, each controlled by an embedded controller. The terminal executes an application program on an operating system such as a mobile operating system or a desktop operating system. The terminal uses application frameworks, including a graphical user interface toolkit, a media acquisition library, and a network communication library, to implement user interaction. The server executes one or more application programs on a server operating system and uses a web application framework, a three-dimensional graphics engine, a computer-aided design (CAD) automation library, and a scheduling engine library to perform the processing described in the claims. The terminal acquires a prompt sentence and other product specification information from a user. The user operates a touch-sensitive display to select a product category, a shape option, a color option, a dimension, a material, and functional requirements from visual components rendered by the terminal application. The terminal converts these selections into structured specification data, for example by constructing a record with fields such as category, base_shape_id, color_code, size_parameters, material id, and functional_flags. The terminal also acquires free-form text typed by the user, and voice input captured through the microphone and converted to text by a speech-recognition library. The terminal stores the text as a prompt sentence. The user can, for example, input prompt sentences such as “black leather backpack, 20-liter capacity, water-resistant,” “blue wool sweater, size M, V-neck,” “wooden dining table, length 180 centimeters, width 90 centimeters, natural finish,” “running red sneakers, size 26 centimeters, breathable mesh material,” “outdoor waterproof jacket, size L, lightweight material,” or “home office wooden desk, width 120 centimeters, depth 60 centimeters, dark brown finish.” The terminal transmits the prompt sentence and the structured specification data to the server over a secure communication protocol. The server receives the prompt sentence and the structured specification data. The server represents the structured specification data in a fixed schema in working memory, for example as objects with strongly typed fields for numerical dimensions and enumerated identifiers for materials and product categories. The server constructs, as an additional data structure, a feature vector representing the prompt sentence and the structured specification data. The server uses a tokenizer to convert the prompt sentence into token indices and combines these with encoded categorical features (such as one-hot or embedding indices for product category, material, and function tags) and normalized numerical features (such as dimension values scaled to a standard range). The server uses a generative AI model to infer missing items or recommended parameters for the product specification. In one embodiment, the generative AI model is implemented as a multi-layer neural network having a transformer-based encoder-decoder architecture. The server configures the model with an embedding layer for tokens and categorical features, multiple self-attention layers for context aggregation, and feed-forward layers for producing both sequence outputs and scalar outputs. The server uses an attention mechanism with learned query, key, and value matrices, a layer normalization procedure, and rectified linear unit activation in dense layers. The server pre-trains the generative AI model on a corpus of product descriptions and structured specifications using supervised learning. The server stores model parameters as weight matrices and bias vectors. During training, the server computes a loss function that includes at least a cross-entropy term for discrete attribute predictions and a mean squared error term for continuous parameter predictions. The server uses stochastic gradient descent with an adaptive learning-rate algorithm to update model weights. The server optionally applies data augmentation by perturbing dimension values within valid tolerances and by paraphrasing prompt sentences, thereby improving robustness and reducing overfitting. At runtime, the server calls the generative AI model with the tokenized prompt sentence and the encoded specification features as input. The server sets inference parameters such as temperature, top-k or top-p sampling thresholds, and maximum output length. The model outputs a structured representation that may be formatted as key-value pairs or a short sequence encoding attributes such as recommended sole thickness, reinforcement positions, pocket locations, cushioning levels, or knit density. The server parses this output by applying deterministic parsing rules, range checks, and type checks, and maps the output into the internal schema for extended specification data. The server uses rule-based post-processing in addition to the generative AI output. For example, the server applies non-conventional rules that combine learned recommendations with hard constraints derived from manufacturing capabilities, such as minimum bend radius for a given material, maximum supported dimension for a given machine, or load-bearing limits for structural members. The server resolves conflicts between learned recommendations and these rules by applying priority weights and constraint-checking algorithms, rather than merely accepting the AI suggestion. This hybrid approach results in extended specification data that satisfies both user intent and physical constraints. The extended specification data unifies natural-language-derived parameters and explicitly entered parameters into a single data structure. The server writes this extended specification data as a canonical representation that is shared across the three-dimensional engine, the CAD automation component, and the process-planning component. Because all subsystems refer to the same extended specification data, redundant mappings and conversions between different formats are reduced, which decreases memory usage and processing time in comparison to architectures in which each subsystem maintains its own independent parameter set. The server uses the extended specification data to generate three-dimensional shape data and material data. In one embodiment, the server uses a three-dimensional graphics engine running on a graphics processing unit to load a base mesh corresponding to the product category. The server applies geometric transformations to the base mesh by computing scale factors and deformation parameters derived from the dimension values in the extended specification data. The server computes material parameters such as diffuse color, specular intensity, roughness, and normal map scaling from the material_id and functional_flags. The server encodes this result as three-dimensional shape data and material data in an internal scene representation. The server generates three-dimensional display data that includes the scene representation and camera parameters. The server selects an initial camera pose and at least one default lighting configuration. The server stores the three-dimensional display data in a format that supports incremental updates to material and geometry parameters without reloading the entire model, for example by separating static geometry buffers from dynamic parameter buffers. This design improves rendering efficiency because the server and terminal can update small parameter sets instead of re-transmitting full meshes for every change. The server transmits the three-dimensional display data to the terminal, where the terminal renders the three-dimensional preview using a three-dimensional rendering library. The terminal accepts user input gestures such as rotation, zoom, and selection of alternative options. The terminal transmits only parameter deltas, such as new color codes, new dimension inputs, or function flags, to the server. The server applies these deltas to the extended specification data, re-evaluates only the affected portions of three-dimensional shape data or material data, and regenerates updated three-dimensional display data. This incremental update mechanism reduces network bandwidth and server computation compared with regenerating full scene data for every user interaction. The server controls design software to generate detailed design data. The server uses a CAD automation interface that can receive parametric instructions. The server maps elements of the extended specification data to CAD parameters such as sketch dimensions, feature depths, radii of curvature, pattern repetitions, and shell thicknesses. The server instructs the CAD software to create sketches, apply constraints, and construct solid features such as extrusions, fillets, and shells in a deterministic order defined by a CAD template. The server ensures that all values are taken from the extended specification data so that three-dimensional preview and CAD model remain consistent. The server uses the generative AI model in the context of the CAD pipeline as well. In one embodiment, the server constructs a prompt based on partially defined CAD parameters, such as “Given a running shoe with breathable mesh upper and high cushioning, suggest heel thickness, forefoot thickness, and heel-to-toe drop in millimeters.” The model outputs numeric values; the server clamps these values within material-specific ranges defined by engineering rules, then updates CAD parameters accordingly. This non-human, algorithmic refinement path allows the system to explore configurations that a human designer may not explicitly specify, while still conforming to safety and manufacturability constraints. The server extracts component configuration data from the CAD model by calling a bill-of-materials generation routine. The server obtains part identifiers, quantities, and associated materials directly from the CAD model feature tree. The server stores this component configuration in a normalized relational structure so that process-planning algorithms can perform joins and aggregations efficiently. The server uses a scheduling and process-planning engine to convert the design data and component configuration into process planning data and work instruction data. The server maintains a machine capability database that indicates, for each type of production equipment, supported operations, capacity, and parameter ranges. The server executes a planning algorithm that maps each required operation (for example, cutting a panel, forming a sole, stitching a seam) to an eligible machine, and orders the operations to satisfy precedence constraints. In one embodiment, the server uses constraint-satisfaction and heuristic search algorithms that take as input the extended specification data, thus allowing product-level characteristics (such as material difficulty or tolerance requirements) to affect machine selection and process order. The server then computes a process schedule by assigning start times and end times to each work instruction based on machine availability and predicted operation durations. The server stores the process schedule in a time-indexed structure and exposes it to a monitoring module. The server receives production progress information, such as machine status updates and operation completion events, from the production facility via an industrial communication protocol. The server compares actual timestamps with planned timestamps and computes deviations. When the server detects a deviation beyond a threshold, the server recalculates portions of the process schedule by re-running the scheduling algorithm only for affected operations and machines. Because the process schedule is stored in a structured, machine-readable form tied back to work instruction identifiers, the server can perform partial rescheduling without reconstructing the entire schedule, which reduces computation time and stabilizes the manufacturing pipeline. The server converts work instruction data into specific control commands for production equipment. The server generates, for example, cutting paths encoded as numerical coordinates and feed rates for a cutting machine, press cycles and temperatures for a forming machine, and stitch paths for a joining machine. The production devices execute these commands under closed-loop control. The server receives feedback such as completion flags and error codes and updates the production progress information, thus closing the loop between digital planning and physical manufacturing. The server generates delivery information when manufacturing is complete. The server determines a delivery route and delivery means by applying route selection algorithms to location data, carrier capability data, and desired delivery windows. The server assigns tracking identifiers obtained from a logistics system and constructs tracking information data structures. The server provides this delivery information to the terminal so that the user can monitor the physical movement of the product. This configuration produces several technical effects. Because the server uses a common extended specification data structure across the generative AI model, the three-dimensional engine, the CAD software, and the process-planning engine, the number of data transformations and schema conversions is reduced, which lowers CPU usage and memory access overhead. Because the server uses incremental update mechanisms for three-dimensional display data and extended specification data, the communication load between the server and the terminal is reduced, which results in faster interactive responses and lower network bandwidth consumption. Because the generative AI model is tightly integrated with rules and constraint checks, the system produces specifications that not only match user intent but also conform to machine and material constraints, reducing the need for manual correction. Additionally, the system improves the internal operation of the computer by providing a non-conventional combination of transformer-based inference, canonical specification data representation, rule-based constraint enforcement, incremental scene updates, and partial rescheduling algorithms that collectively optimize computation flow and data management. The server does not merely automate human mental activity; instead, the server constructs feature vectors, applies learned weight matrices and loss-optimized decision boundaries, and performs constraint-checked inference of numerical design parameters at a speed and scale that is unattainable by human designers. The server thereby improves the accuracy and consistency of generated design data and process plans, reduces errors due to mismatches between visualization and manufactured geometry, and accelerates convergence from user input to manufacturable configuration. In alternative embodiments, the server can employ different neural network architectures, such as recurrent neural networks or convolutional networks, as the generative AI model, provided that the model consumes prompt sentences and structured specification data and outputs recommended parameters that can be integrated into extended specification data. The server can store the canonical extended specification data in different database technologies, such as relational databases or document stores, as long as a unified schema is maintained. The server can implement different three-dimensional engines and CAD platforms, provided that these components accept parametric inputs derived from the extended specification data. In still other embodiments, the terminal can be a head-mounted device or a kiosk, and the production equipment can include additive manufacturing devices. The core concept of using a generative AI model and a unified extended specification data structure to drive three-dimensional preview, automatic design generation, and dynamic process planning remains the same. By maintaining the described data flow, feature encoding, and constraint integration, the system provides improved computational efficiency, higher design accuracy, and more reliable control of physical manufacturing equipment.

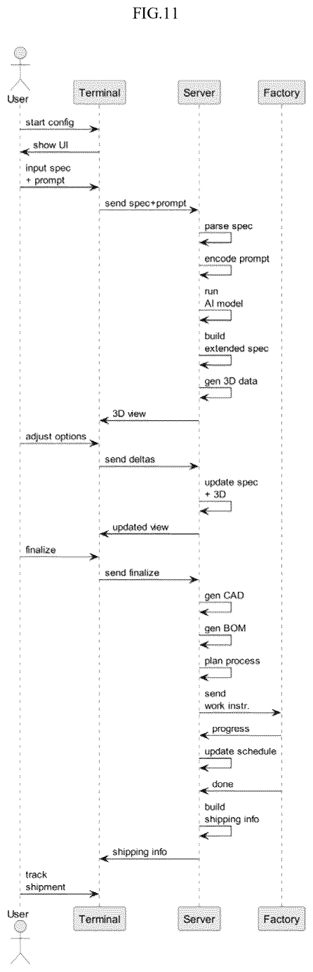

The following describes the processing flow using FIG. 11.

### Step 1:

The user operates the terminal to start a product configuration. The terminal initializes an in-memory data structure for specification information.

Input: no prior user data (initial state).

Processing: the terminal allocates a record with empty fields such as category, shape_id, color_code, size_parameters, material_id, functional_flags, and prompt_sentence.

Output: an initialized specification record stored in the terminal's working memory.

### Step 2:

The user inputs structured options via the touch interface of the terminal. The terminal displays selectable items (product categories, shapes, colors, sizes, materials, functions) using graphical components.

Input: user touch events (taps, selections, slider movements) on the display.

Processing: the terminal maps each touch event to a selected option, converts UI selections into standardized codes (for example, category IDs, shape IDs, RGB color codes, numeric dimensions, material IDs), and updates the corresponding fields in the specification record.

Output: a partially filled specification record containing structured values for category, shape, color_code, size_parameters, material_id, and functional_flags.

### Step 3:

The user provides a prompt sentence via text input or voice input on the terminal. The terminal acquires a free-form natural-language description from the user.

Input: keyboard text or microphone audio.

Processing: if audio is used, the terminal sends the audio to a speech-recognition function, receives transcribed text, and stores this text as the prompt_sentence. The terminal may perform basic tokenization and language normalization (such as lowercasing, removal of extra spaces) and attaches the normalized string to the specification record.

Output: an updated specification record including the prompt_sentence field.

### Step 4:

The user optionally captures a reference image using the camera of the terminal. The terminal associates the captured image with the current specification. Input: user request to take a photo and image frames from the camera sensor.

Processing: the terminal encodes the captured image into a compressed format, saves the file with a unique identifier, and records a reference to this identifier in an image_reference field of the specification record.

Output: a specification record that includes a pointer to at least one reference image.

### Step 5:

The user requests a three-dimensional preview on the terminal. The terminal prepares data for transmission to the server.

Input: the current specification record containing structured fields, the prompt_sentence, and any image_reference.

Processing: the terminal serializes the specification record into a structured network message (for example, JSON) and attaches device and session metadata.

Output: a request message transmitted from the terminal to the server.

### Step 6:

The server receives the specification data and the prompt sentence from the terminal. The server converts the transmitted data into internal objects.

Input: the request message containing serialized specification fields, the prompt_sentence, and metadata.

Processing: the server parses the message, validates field types and ranges, and constructs an internal specification object with fields mapped to predetermined data types (for example, integers for sizes, enumerations for materials, strings for category names).

Output: an internal baseline specification object stored in server memory.

### Step 7:

The server encodes the prompt sentence and the structured fields for use by the generative AI model. The server builds a feature representation combining language and numeric data.

Input: the prompt_sentence string and the baseline specification object.

Processing: the server tokenizes the prompt_sentence into subword tokens, maps tokens to vocabulary indices, and encodes categorical fields (such as category and material) as embedding indices. The server normalizes numeric dimensions into a fixed range and concatenates these as additional feature vectors.

Output: an encoded input bundle containing token indices, embedding indices, and normalized numeric features.

### Step 8:

The server executes the generative AI model to infer missing or optimized specification parameters. The server performs neural network inference using the encoded input bundle.

Input: the encoded input bundle with token indices and feature vectors.

Processing: the server feeds the bundle into a neural network comprising embedding layers, multi-head attention layers, and feed-forward layers. The server computes intermediate activations, applies attention weights to combine contextual information, propagates signals through hidden layers, and produces output logits or continuous values that correspond to recommended attributes (such as dimensions, performance levels, or structural reinforcements). The server applies softmax for categorical outputs and linear activation for numeric outputs, then decodes these into human-interpretable parameters.

Output: a set of inferred items and recommended parameter values (for example, recommended sole_thickness, cushioning_level, reinforcement_positions).

### Step 9:

The server integrates the inferred parameters into extended specification data. The server resolves conflicts and enforces constraints.

Input: the baseline specification object and the inferred parameter set from the generative AI model.

Processing: the server compares inferred values with existing fields, applies precedence rules and constraint checks (such as dimensional limits and machine capability constraints), and overwrites or supplements baseline fields where permitted. The server produces an extended specification object that includes both user-entered and AI-inferred parameters.

Output: an extended specification object used as a canonical representation for subsequent processing.

### Step 10:

The server generates three-dimensional shape data based on the extended specification. The server computes geometric transformations and structural parameters.

Input: the extended specification object, including category, size_parameters, and structural parameters.

Processing: the server selects a base mesh template appropriate for the product category, reads size parameters to compute scaling factors along principal axes, and applies these factors to vertex positions. When structural parameters are specified, the server modifies mesh topology or attaches sub-components (for example, additional supports) by performing mesh operations defined in a geometry engine.

Output: three-dimensional shape data describing the customized product geometry.

### Step 11:

The server generates material data corresponding to the extended specification. The server assigns visual and physical material attributes.

Input: the extended specification object, especially material_id, color_code, and functional_flags.

Processing: the server looks up material properties from a material database, assigns base color values derived from color_code, and sets shader parameters (such as roughness, metallic factor, transparency) according to material type and function (for example, water-resistant or breathable). The server may also choose appropriate texture maps and map scales.

Output: material data describing visual and surface properties for the three-dimensional rendering.

### Step 12:

The server constructs three-dimensional display data for rendering on the terminal. The server packages geometry, material, and camera settings.

Input: three-dimensional shape data and material data.

Processing: the server generates a scene description that includes mesh buffers, material definitions, and default camera and light positions. The server encodes the scene in a format that the terminal rendering engine can interpret and identifies which parameters can be updated incrementally (for example, color or small geometry deformations).

Output: three-dimensional display data ready for transmission.

### Step 13:

The server transmits the three-dimensional display data to the terminal. The terminal receives and renders the data.

Input: the three-dimensional display data from the server.

Processing: the terminal parses the scene description, allocates GPU buffers for meshes and textures, and initializes a rendering pipeline with the provided camera and light configurations.

Output: a visible three-dimensional preview of the product on the terminal display.

### Step 14:

The user interacts with the three-dimensional preview on the terminal. The terminal captures user manipulation of the preview.

Input: user gestures such as rotation, pinch-to-zoom, and option changes on the display.

Processing: the terminal converts gestures into camera rotation and zoom parameters for local rendering, and converts changes in options (such as a new color or size) into updated specification values. For option changes, the terminal builds delta messages that include only modified fields.

Output: updated camera views rendered locally, and delta messages containing changed specification data transmitted to the server.

### Step 15:

The server updates the extended specification data in response to user modifications. The server recalculates affected portions of the three-dimensional data.

Input: delta messages containing changed specification fields.

Processing: the server applies changes to the extended specification object, identifies dependent parameters (for example, a size change affecting length and width), and recomputes only the relevant parts of the shape data or material data. The server avoids recomputing unchanged mesh sections, thus reducing computation.

Output: updated three-dimensional display data for the modified aspects of the product.

### Step 16:

The server sends updated three-dimensional display data to the terminal. The terminal refreshes the preview.

Input: updated three-dimensional display data.

Processing: the terminal updates material parameters or specific buffers while maintaining previously loaded meshes and textures, and redraws the preview.

Output: an updated interactive three-dimensional preview that reflects the user's latest changes.

### Step 17:

The user confirms the product design through the terminal. The terminal notifies the server of finalization.

Input: user confirmation action (for example, pressing a “Finalize” button).

Processing: the terminal sends a finalization message including the current identifier of the extended specification.

Output: a finalization request message received by the server.

### Step 18:

The server locks the extended specification and initiates CAD generation. The server converts specification parameters into CAD instructions.

Input: the locked extended specification object.

Processing: the server maps dimensions and structural parameters to CAD parameters, such as sketch dimensions and feature heights, and invokes a CAD automation interface to create parametric sketches, apply geometric constraints, and generate solid bodies by executing feature operations (extrude, cut, fillet, shell).

Output: CAD design data representing detailed product geometry.

### Step 19:

The server generates a component configuration (bill of materials) from the CAD data. The server extracts parts and their attributes.

Input: CAD design data.

Processing: the server traverses the CAD model's feature and component tree, identifies distinct components, and reads associated attributes (material, thickness, volume). The server aggregates these into a list of components with quantities and attributes.

Output: component configuration data suitable for manufacturing planning.

### Step 20:

The server creates process planning data from the design data and component configuration.

The server selects equipment and defines process order.

Input: CAD design data, component configuration data, and machine capability data.

Processing: the server identifies operations required to fabricate each component, queries a machine database to find eligible equipment, and assigns each operation to a machine based on capability and available capacity. The server orders operations according to dependency constraints and creates a sequence of process steps.

Output: process planning data specifying which machine performs which operation and in what order.

### Step 21:

The server generates work instruction data and a process schedule. The server assigns temporal information to operations.

Input: process planning data and current production status (such as machine calendars).

Processing: the server estimates processing times, schedules start and end times for each operation, and stores work instructions with associated timestamps.

Output: work instruction data and a process schedule ready to be sent to production equipment.

### Step 22:

The server monitors production progress and dynamically updates the schedule.

The server responds to delays or machine status changes.

Input: production progress information from production equipment (for example, operation completion events, error signals).

Processing: the server compares actual completion times with scheduled times, detects deviations, and recomputes schedules for affected operations by reprioritizing tasks or reassigning them to alternate machines.

Output: an updated process schedule and updated work instructions, reducing production bottlenecks.

### Step 23:

The server controls production equipment based on work instruction data. The production devices perform machining, assembly, and finishing.

Input: work instruction data specifying machine identifiers, tool paths, and process parameters.

Processing: the server translates work instructions into machine-level commands (for example, coordinate paths, feeds, speeds, temperature profiles) and sends these commands to the corresponding production equipment controllers.

Output: physical manufacturing actions executed by machines, resulting in fabricated product components and assembled products.

### Step 24:

The server generates delivery information after manufacturing is completed. The server prepares route, means, and tracking data.

Input: completion information for the product, logistics constraints, and carrier data.

Processing: the server selects a delivery route and delivery means, registers the shipment with a logistics system to obtain a tracking identifier, and packages this data as delivery information.

Output: delivery information including route details, transport mode, and tracking identifier.

### Step 25:

The server transmits delivery information to the terminal. The user monitors delivery status.

Input: delivery information stored at the server and tracking updates from carriers.

Processing: the server provides the initial delivery information to the terminal and periodically queries carrier systems for updated tracking events, then sends these updates to the terminal. The terminal displays current location, status, and estimated delivery time to the user.

Output: a continuously updated view of the shipment status on the terminal, allowing the user to track the real-world movement of the manufactured product.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented product customization and manufacturing systems suffer from several technical limitations in how they acquire, interpret, and use user input for downstream three-dimensional (3D) modeling, design generation, and manufacturing control. First, known systems typically rely on rigid, form-based graphical user interfaces, where users select discrete options from predefined menus. Such interfaces require the user to adapt to the system's internal parameter model and do not exploit richer input modalities such as continuous motion in a virtual space or natural language utterances. As a result, a server must perform multiple context switches between disconnected input channels, and the mapping logic from user actions to structured product specifications becomes fragmented and inefficient. This often leads to increased processing latency, redundant conversions between data formats, and higher error rates when transforming user intent into machine-interpretable design parameters. Second, existing systems generally treat three-dimensional preview generation and engineering design as separate, loosely-coupled stages. In many implementations, a visualization engine produces a simplified 3D preview solely for display purposes, while a separate computer-aided design (CAD) tool independently constructs engineering models for manufacturing. This decoupling forces repeated data translation between heterogeneous representations, requires non-trivial manual reconciliation of visualization parameters and engineering parameters, and prevents real-time co-evolution of the visual preview and the underlying design data on a single, coherent data model. This results in computational inefficiency, increased memory use, and reduced responsiveness of the system to iterative user modifications. Third, while generative AI models have emerged, conventional usage patterns typically apply such models at the periphery of the system, for example to generate textual marketing descriptions or rough conceptual sketches. The prompt sentences provided to generative AI models are often manually crafted, not normalized, and not linked to a structured internal representation of product attributes. Consequently, the outputs of generative AI models are not directly exploitable by downstream CAD, process planning, and manufacturing control components, and substantial manual interpretation or rule-based post-processing remains necessary. This leads to non-deterministic behavior, inconsistent design outputs, and difficulty in integrating generative AI results into reliable, repeatable production workflows. Fourth, process planning and manufacturing control are often executed using static, pre-defined routing tables and fixed machine assignments. Changes in user specifications or generative AI-derived design refinements cannot be propagated efficiently and in real time to the manufacturing process plan. The server must re-run large portions of planning logic or rely on manual reconfiguration, leading to degraded throughput, poor resource utilization, and an inability to dynamically rebalance loads when bottlenecks appear on the production line. Accordingly, there is a need for a computer-implemented system that technically improves the way a processor acquires and unifies heterogeneous input signals (motion in virtual reality, voice, and natural language prompt sentences), transforms them into a normalized, machine-usable product specification, and tightly integrates that specification with (i) real-time 3D modeling for virtual reality, (ii) a generative AI model via standardized prompt sentences, and (iii) automated CAD-based design generation, process planning, and manufacturing control. Such a system should reduce the number of format conversions and manual interventions, lower latency in updating 3D previews and design data in response to user actions, and allow stable and predictable use of generative AI outputs as direct input for detailed design and production. In particular, there is a need to architect the server-side processing so that the same structured specification and standardized prompt sentences feed both visual and engineering pipelines, thereby improving overall computational efficiency, responsiveness, and reliability of end-to-end mass-customization workflows.

The specific processing by the specific processing unit 290 of the data processing device 12 in Application Example 1 is realized by the following means.

The present invention provides a server comprising a processor configured to receive, from a consumer terminal, motion information in a virtual space and a natural language prompt sentence describing a product, to convert the motion information and the natural language prompt sentence into a unified structured product specification stored in a machine-readable data structure, to automatically generate, from the structured product specification, a standardized prompt sentence including at least a product category, an intended use, a dimension, a color, a material, and a functional requirement, to supply the standardized prompt sentence as input to a generative AI model and obtain, from the generative AI model, at least one of a complementary product specification or a design candidate, to integrate an output of the generative AI model into the structured product specification, to generate three-dimensional model data for a virtual reality output device based on the structured product specification and the integrated output, to update, in real time, a three-dimensional preview that is rotatable, scalable, and placeable in the virtual space in response to iterative modifications of the structured product specification, to generate detailed design data and parts list data based on the structured product specification and the integrated output using a computer-aided design engine, to generate manufacturing process plan data based on the detailed design data and the parts list data with reference to facility information and load information, and to control manufacturing equipment according to the manufacturing process plan data while monitoring manufacturing state information and updating the manufacturing process plan data. This enables a technical improvement in computer-based product customization and manufacturing by unifying multi-modal user input into a single structured specification that is consistently shared across a virtual reality rendering pipeline, a generative AI pipeline, and a computer-aided design and manufacturing pipeline, thereby reducing data translation overhead, decreasing latency in 3D preview and design updates, and enabling stable, automated use of generative AI outputs in end-to-end, real-time controlled production workflows.

The term “consumer” refers to a human user who interacts with the system to specify, customize, and purchase a product using one or more input devices.

The term “consumer terminal” refers to an information processing device operated by a consumer, including at least one display unit and at least one input unit, and configured to communicate with the server over a communication network. The term “virtual reality output device” refers to a display apparatus that presents a three-dimensional virtual space to a user, including at least a head-mounted display or other stereoscopic display capable of rendering three-dimensional scenes in response to head or body motion. The term “operation device” refers to an input apparatus, such as a handheld controller, glove-type device, gesture sensor, or similar device, that detects a user's pointing, gripping, or other gestures in a virtual space. The term “voice input device” refers to an apparatus, such as a microphone or microphone array, that acquires acoustic signals representing a user's speech for subsequent speech recognition processing. The term “motion information in a virtual space” refers to data representing a user's position, orientation, gesture, or interaction with a virtual object in a three-dimensional coordinate system of a virtual environment. The term “natural language prompt sentence” refers to a sequence of words in a human language expressing a user's request or intention regarding a product, including at least desired attributes such as category, use case, dimensions, color, material, or functional requirements.

The term “standardized prompt sentence” refers to a natural language prompt sentence generated by the system according to a predefined template and attribute mapping rule, and including normalized attribute fields such as product category, intended use, dimension, color, material, and functional requirement. The term “prompt template” refers to a predefined syntactic and semantic pattern indicating positions and formats for embedding attribute values into a standardized prompt sentence. The term “attribute mapping rule” refers to a rule set that converts internal attribute values of a product specification, such as category codes or numeric dimensions, into textual expressions suitable for inclusion in a standardized prompt sentence. The term “product specification” refers to a structured set of data elements that define attributes of a product to be designed and manufactured, including at least product category, intended use, dimensions, color, material, style, and optional functional requirements. The term “structured product specification” refers to a product specification stored in a machine-readable data structure, such as a record or object including named fields and associated values, suitable for programmatic processing. The term “generative AI model” refers to a trained machine learning model, such as a neural network-based language model, that generates or completes data, including at least natural language text or design-related information, in response to an input prompt sentence. The term “design candidate” refers to an output of the generative AI model or other design engine that proposes at least one possible configuration of structural, dimensional, or functional aspects of a product. The term “complementary product specification” refers to additional or refined attribute values produced by the generative AI model that supplement or adjust an existing product specification. The term “three-dimensional model data” refers to digital data describing a three-dimensional object, including at least geometry information such as vertices, edges, faces, or parametric surfaces, and optionally material and texture information, suitable for rendering or further design processing. The term “three-dimensional preview” refers to a rendered image or interactive representation of the three-dimensional model data that allows a user to visualize the appearance and configuration of a product in a virtual space. The term “three-dimensional preview information” refers to data derived from or associated with the three-dimensional preview, including at least geometric parameters, material assignments, and camera or viewpoint parameters used for rendering. The term “dimension change” refers to a modification of numerical size parameters of a three-dimensional model, such as width, height, depth, or other measurable extents. The term “shape deformation” refers to a modification of a three-dimensional model's geometry that changes its form or contour, including non-uniform scaling, bending, morphing, or other geometric transformations. The term “texture assignment” refers to a process of associating surface appearance data, such as color maps, material maps, or pattern images, with surfaces of a three-dimensional model to simulate materials and finishes. The term “design rule information” refers to data describing constraints, guidelines, or standards that must be satisfied by a product design, including structural constraints, safety requirements, ergonomic limits, and manufacturability conditions. The term “constraint information” refers to limits or conditions applied to design parameters, manufacturing processes, or resource usage, including at least allowable ranges, compatibility rules, and capacity thresholds. The term “detailed design data” refers to engineering-level data that defines the internal structure and components of a product, including precise geometry, tolerances, connection methods, and other attributes required for manufacturing. The term “parts list data” refers to a bill of materials or similar listing that identifies components required for a product, including at least part identifiers, quantities, materials, and key dimensional or functional attributes. The term “computer-aided design engine” refers to a software component that generates and manipulates engineering models of products, including at least the creation, modification, and storage of parametric or geometric CAD data. The term “facility information” refers to data describing manufacturing resources, including at least machines, tools, production lines, and their capabilities, capacities, and operational states. The term “load information” refers to data indicating current or planned utilization of manufacturing resources, including queued tasks, assigned jobs, processing times, and available capacity. The term “manufacturing process plan data” refers to structured data specifying at least the sequence of manufacturing operations, the allocation of operations to particular machines or workstations, and the scheduled start and end times of the operations. The term “manufacturing equipment” refers to physical devices used for production, including at least cutting machines, forming machines, machining centers, assembly stations, inspection devices, and related controllers. The term “machining program” refers to control data for manufacturing equipment, including at least instructions for tool paths, motion, process parameters, and operation sequences. The term “control parameters” refers to numerical or symbolic values used to configure operating conditions of manufacturing equipment, including at least speed, feed, pressure, temperature, and time settings. The term “manufacturing state information” refers to data representing the progress and status of manufacturing operations, including at least start and completion events, error conditions, and quality inspection results. The term “packaging information” refers to data specifying how a finished product should be packed, including at least packaging materials, protective measures, dimensions, weight, and labeling requirements. The term “transportation conditions” refers to constraints or requirements related to shipping a product, including at least delivery time, cost, environmental conditions, and carrier options. The term “shipment information” refers to data specifying details of shipping a product, including at least destination, selected carrier, route, tracking identifier, and estimated delivery time.

The term “delivery status information” refers to data indicating the current progress of shipment of a product, including at least dispatched, in transit, delayed, out for delivery, and delivered states.

In one or more embodiments, a server, a terminal, and a user cooperate to implement a system that acquires multi-modal input in a virtual reality environment, transforms the input into a structured product specification, generates standardized prompt sentences for a generative AI model, and uses outputs of the generative AI model to drive three-dimensional (3D) modeling, detailed design, manufacturing process planning, and control of manufacturing equipment.

### A. Hardware and Software Configuration

A server includes at least one processor, a main memory, a non-volatile storage device, and a network interface. The server executes server-side programs implemented, for example, in a general-purpose programming language on top of an operating system. The server runs modules including an input processing module, a specification generation module, a 3D modeling interface module, a design processing module, a process planning module, and a manufacturing control module. The server also has access to a database system, such as a relational database, and optionally an in-memory data store, to store structured product specifications, standardized prompt sentences, model parameters, manufacturing resources, and state information.

A terminal includes a head-mounted display device, a pair of hand-held controllers or equivalent operation devices, a voice input device such as a microphone, a graphics processing unit, and a network communication module. The terminal executes a virtual reality application built with a game engine such as a general-purpose 3D engine. The virtual reality application renders a virtual store space and communicates with the server via a communication network.

A user wears the head-mounted display device and operates the operation devices in the virtual space. The user provides voice input through the voice input device. The user interacts with virtual product objects by pointing, gripping, or moving them in the virtual environment, and by speaking natural language instructions.

### B. Data Structures and Internal Representations

The server uses a structured product specification as a central data structure. The structured product specification is, for example, an object or record with named fields, such as:
product_category (e.g., furniture, footwear, garment, electronic device),
intended_use (e.g., living room, outdoor running, office work),
dimensions (e.g., width, depth, height, shoe size),
color,
material,
style (e.g., modern, classic),
functional_requirements (e.g., “supports three adults,” “waterproof,” “breathable”).

The server associates each structured product specification with a session identifier and a product identifier. The server stores each structured product specification in the database and optionally in an in-memory cache for rapid access.

The server also manages a prompt template and attribute mapping rules. The prompt template is a string pattern with placeholders for attribute values, such as:
“[intended_use] [product_category], [color], [dimensions], [material], [functional_requirements].”

The attribute mapping rules convert internal codes and numerical values into textual fragments suitable for inclusion in a prompt sentence.

The server maintains additional data structures for:
three-dimensional model parameters (e.g., base mesh identifier, scaling factors, shape indices),
design rule information and constraint information (e.g., allowable thickness ranges, maximum span without reinforcement, material compatibility),
facility information (e.g., list of machines, capabilities, processing speeds),
load information (e.g., current queue length for each machine, estimated completion times),
manufacturing process plan data (e.g., a directed acyclic graph of operations with assigned resources and time slots),
manufacturing state information (e.g., operation status flags, timestamps, quality results).

### C. Acquisition and Transformation of User Input

The terminal executes the virtual reality application to render a virtual store and product objects. The terminal tracks the user's head pose and controller poses using tracking sensors and a virtual reality runtime. The terminal sends motion information, including position, orientation, and interaction events such as ray-cast hits and grasp actions, to the server via a network protocol.

The terminal acquires voice input through the microphone. When the user presses a designated button or performs a gesture to start voice input, the terminal captures audio samples, encodes them into a digital audio stream, and sends the audio stream to the server. The server receives the motion information and the audio stream. The server associates the motion information with specific virtual objects based on identifiers embedded in the interaction events (for example, a product ID attached to a 3D object in the virtual space). The server uses this association to determine which product the user is manipulating. The server performs speech recognition on the audio stream using an automatic speech recognition model. The speech recognition model may be implemented as a deep neural network, for example a hybrid model combining convolutional layers and recurrent or transformer layers, trained on speech-to-text pairs. The server converts the audio stream into text representing the user's utterance.

The server parses the recognized text in combination with the motion information. For instance, the user may say:

“Make this sofa dark gray fabric, width 200 centimeters, depth 90 centimeters, modern design, comfortable for three people.”

The server splits the utterance into tokens, identifies key phrases using a natural language parser, and maps them to fields in the structured product specification:
product_category: sofa,
color: dark gray,
material: fabric,
dimensions: width 200 cm, depth 90 cm,
style: modern,
functional_requirements: comfortable for three people.

The server uses a rule-based mapping layer combined with a generative AI model to disambiguate and normalize the text. The rule-based layer applies domain-specific grammars and dictionaries to identify colors, materials, dimensions, and categories. The generative AI model is then applied to resolve ambiguous expressions, infer missing attributes, or reconcile inconsistent values. For example, if the user said “large enough for three adults,” the generative AI model can infer the required seating width and map it to a dimension value.

### D. Generative AI Model Structure and Training

The server uses a generative AI model implemented as a multi-layer transformer neural network trained on text sequences that include product descriptions, design constraints, and example engineering annotations. The model comprises, for example, N encoder-decoder blocks with self-attention and cross-attention layers, layer normalization, and feedforward sub-layers. The model parameters include weight matrices for query, key, and value projections in the attention mechanism, projection matrices in feedforward layers, and embedding matrices for tokens and positional encodings. The server trains the generative AI model using a loss function such as cross-entropy over predicted token distributions, with additional regularization terms to encourage adherence to design constraints. The training data includes pairs of input prompt sentences and output design-related annotations, such as structural proposals (e.g., “add cross brace for span over 180 cm”) and parameter completions (e.g., “use foam density 30 kg/m3 for medium-firm cushion”). The server updates the model weights by gradient-based optimization, for example using an adaptive learning rate optimizer. The server optionally performs fine-tuning on domain-specific data representing products and designs in the target domain. The server may also use data augmentation techniques such as synonym substitution and paraphrasing for prompt sentences, and scaling of numeric parameters within safe ranges, to improve robustness. Because the generative AI model operates over standardized prompt sentences that are tightly coupled to the structured product specification, the outputs of the generative AI model directly map back into the internal data structures without manual intervention. This architecture differs from conventional use of AI as a loosely-coupled text generator and improves determinism and data integrity.

### E. Standardized Prompt Sentence Generation and AI-Based Specification Expansion

The server constructs a standardized prompt sentence from the structured product specification using the prompt template and attribute mapping rules. For example, the server generates:

“Running red sneakers, size 26 centimeters, breathable mesh material.”

“Waterproof jacket for outdoor use, size L, lightweight material.” “Wooden desk for a home office, width 120 centimeters, depth 60 centimeters, dark brown finish”

“Dark gray fabric sofa for a living room, width 200 centimeters, depth 90 centimeters, modern design, comfortable seating for three adults.”

The server passes the standardized prompt sentence to the generative AI model and receives an output sequence. The output sequence may include explicit parameter suggestions, such as recommended frame cross-section dimensions, reinforcement locations, stitching patterns, or internal layer compositions.

The server parses the output sequence using a predetermined schema, where specific markers or keywords in the output map to fields within the structured product specification. For instance, if the output contains:
“frame_material: hardwood; leg_type: tapered metal; cushion_firmness: medium; foam_density: 30 kg/m³,”
the server updates corresponding fields in the structured product specification. If the output contains a design rule recommendation, such as “add center support leg for span over 180 cm,” the server evaluates the current dimensions and modifies the internal structural configuration accordingly. By using a standardized prompt sentence and a fixed output schema, the server ensures that the generative AI model is integrated into a closed-loop computational pipeline rather than being used as a free-form text generator. This reduces ambiguity, improves the reliability of AI-generated parameters, and allows the AI outputs to be directly consumed by the CAD and process planning modules.

### F. 3D Modeling and Virtual Reality Presentation

The server interfaces with a 3D modeling engine to create and update three-dimensional model data. The server stores base meshes for each product category and a set of parametric transformation rules. When the structured product specification changes, the server calculates new scale factors and shape parameters and applies them to the base mesh. The server assigns materials and textures using material libraries containing physical properties and visual textures that correspond to values in the structured product specification. The server sends either updated 3D model data to the terminal for local rendering or renders frames on the server and streams them to the terminal. The terminal renders the product within the virtual environment and allows the user to rotate, scale, and reposition the product. The terminal synchronizes user interactions with the server, so additional changes in the structured product specification can be processed and re-rendered promptly. By keeping the same structured product specification as the source for both the 3D preview and the detailed design data, the system avoids multiple incompatible representations and reduces conversion overhead. This results in faster update cycles for the user-visible preview, which is a technical improvement in responsiveness.

### G. Detailed Design Generation Using CAD

The server uses a computer-aided design engine to generate detailed design data and parts list data. The server maps the structured product specification and AI-augmented parameters to parametric CAD features. For example, for a sofa, the server defines:
parametric sketches for side frames, cross members, and seat supports,
extrusions and cuts based on dimension fields,
assembly constraints between frames, cushions, and legs.

The server invokes CAD engine functions to resolve constraints and generate a fully constrained 3D assembly model. From this CAD model, the server extracts geometry for each part and computes a bill of materials that lists quantities, materials, and dimensions. The design rule information and constraint information are applied during this step. If the structured product specification leads to a design that violates a rule, such as a span exceeding a maximum allowable length without support, the server automatically inserts additional structural elements or adjusts dimensions within allowed ranges. Because the generative AI model already suggests rule-compliant configurations, the number of iterations required to achieve a valid design is reduced, which in turn reduces server-side computation and memory usage.

### H. Manufacturing Process Planning and Equipment Control

The server uses the detailed design data and parts list data as inputs to a process planning algorithm. The process planning module uses facility information and load information to compute an optimized assignment of operations to machines and time slots. The algorithm may use graph-based scheduling and heuristic or integer programming techniques to minimize makespan, balance machine load, or reduce changeover times. The server generates manufacturing process plan data that includes a sequence of operations (e.g., cutting, drilling, forming, assembly, inspection), the assigned machine identities, and expected start and end times. Because the plan is computed from detailed geometric and material data, the server can generate machine-level control programs, such as tool paths for cutting machines, based on the exact shapes and materials of parts. The server transmits these control programs and associated control parameters to manufacturing equipment controllers. The servers receive manufacturing state information from sensors or machine controllers and update the manufacturing process plan data when deviations occur, such as delays or failures. The server may re-run the scheduling algorithm incrementally to shift operations to alternative machines, thus performing dynamic load balancing. This tight integration between the design data, AI-derived parameters, and manufacturing control allows the system to respond to changes in product specifications without fully restarting the planning process. As a result, the server can reduce computation time and network traffic compared to systems in which each adjustment requires a complete re-export and re-import of design data between disparate subsystems.

### I. Technical Effects and Computer-Technology Improvements

The server improves computer technology in several ways. First, by unifying multi-modal user input (motion and natural language) into a single structured product specification and by generating standardized prompt sentences tightly coupled to that specification, the server reduces the need for multiple ad hoc parsing layers and manual synchronization between independently developed components. This unification decreases data redundancy and memory footprint. Second, by designing the generative AI model to operate on standardized prompt sentences and produce outputs mapped directly to structured fields, the server achieves a deterministic and machine-usable integration of generative AI into the design pipeline. This differs from simple automation of human tasks, because the model is trained and constrained to generate structured, rule-compliant outputs that are immediately consumable by CAD and scheduling algorithms, and the server enforces schema-level checks over the AI outputs before acceptance. Third, by coupling the structured product specification to both the visual 3D preview and the engineering design model, the server eliminates conventional conversions between “presentation models” and “engineering models.” The server's single-source specification reduces the number of format conversions and mitigates loss of precision, resulting in faster updates, fewer inconsistencies, and less computation for reconciliation. Fourth, by integrating manufacturing process planning with real-time state monitoring and dynamic rescheduling, the server improves the utilization of manufacturing resources and reduces the time-to-completion for customized orders. This is achieved by specific algorithms operating on machine states and process graphs, rather than by purely administrative workflow changes. Fifth, by training and using the generative AI model under explicit constraints and mappings, the server performs computations that humans would find difficult to maintain consistently and in real time, such as continuously rebalancing multiple design trade-offs (comfort, durability, manufacturability) and upstreaming these decisions directly into CAD and process planning modules. The server's architecture thus provides a new technical arrangement of data structures, algorithms, and model interaction that results in reduced latency, improved accuracy of design parameters, and improved management of computational resources.

### J. Variations and Alternative Embodiments

The server may use different types of generative AI models, such as encoder-only models or decoder-only models, as long as they accept standardized prompt sentences and produce structured outputs. The feature extraction and attribute mapping stages may be implemented with different combinations of rule-based modules and neural models. The terminal may be replaced by other devices such as a tablet with motion sensors or a large display with motion tracking cameras. The system may also use alternative input modalities, such as eye-tracking or haptic gloves, but the core concept of translating motion and natural language into a unified structured product specification remains. The CAD engine and process planning modules may be integrated in different configurations; for instance, the CAD engine may run on a separate server, and the process planning module may run on dedicated hardware. The communication between these components may use defined APIs, but the logical flow of using AI-augmented structure as the common source of truth is maintained. Through these embodiments and variations, the server, the terminal, and the user cooperate to implement the claimed system in a manner that enables others skilled in the art to realize the invention, while demonstrating how the particular combination of structured specifications, standardized prompt sentences, generative AI integration, and manufacturing control yields concrete technical improvements over conventional computer-based product customization and production systems.

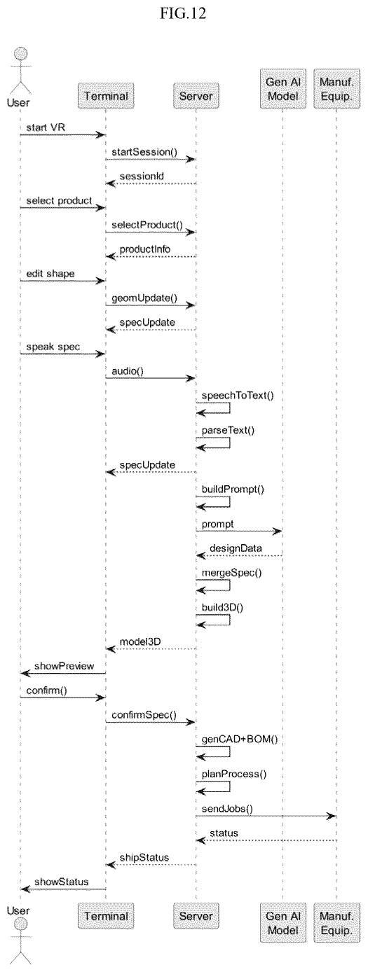

The following describes the processing flow using FIG. 12.

### Step 1:

User wears the head-mounted display and operates the terminal to start a virtual reality application. Terminal initializes tracking of head pose and controller pose using a virtual reality runtime and loads a virtual store scene from local storage. Terminal sends a session start request to the server including a terminal identifier, a user identifier, device capabilities, and an initial camera pose. Server receives the session start input and creates a session record in a database, assigns a session identifier, and returns the identifier and initial configuration data to the terminal. Server processes the session start input by storing the identifiers and capabilities in structured records, and outputs a session context that is used as a key for subsequent data processing and association of product specifications.

### Step 2:

User moves in the virtual store, looks at shelves, and points a controller at a product object. Terminal captures motion information (position, orientation, ray-cast hits) and interaction events (e.g., pointer-on-object, trigger press) as input, and periodically sends this motion and interaction data to the server with the session identifier. Server receives the motion and interaction input and identifies a focused product by matching object identifiers from the motion data to product records in the database. Server processes the motion and interaction input by performing a lookup of product metadata, including base model identifiers and available customization attributes, and outputs structured product metadata back to the terminal. Terminal receives the product metadata and updates the virtual store view by highlighting the product and displaying a basic information panel as output for the user.

### Step 3:

User confirms a product selection by pressing a trigger or performing a grip gesture on the highlighted product. Terminal detects the selection input event, packages the selected product identifier with the session identifier, and sends this selection data to the server. Server receives the selection input, creates an initial structured product specification with default values for category, intended use, dimensions, color, and material, and stores this structured specification in memory and in the database. Server processes the selection data by instantiating a product specification record and associating it with the session and product identifiers, and outputs the structured product specification and an initial prompt-ready attribute set back to the terminal. Terminal uses the output specification to enable an edit mode and displays interaction handles (e.g., scale handles, shape sliders) on the selected product in the virtual scene.

### Step 4:

User manipulates the product in edit mode by grabbing and moving handles to change width, depth, or other shape parameters. Terminal captures the positions of the user's hands or controllers as input and computes geometric deltas (e.g., change in width from 180 cm to 200 cm). Terminal sends updated geometry parameters to the server along with the product identifier and session identifier. Server receives the geometric parameter input and updates the corresponding fields in the structured product specification (e.g., dimensions.width, dimensions.depth). Server processes the geometric input by performing arithmetic computations on the dimension values, validating them against constraint information, and outputs an updated structured product specification and a parameter set for 3D model scaling.

### Step 5:

User presses or holds a voice input button and speaks a natural language specification, such as “Make this sofa dark gray fabric, width 200 centimeters, depth 90 centimeters, modern design, comfortable for three people.” Terminal records the audio signal as input, encodes it into a digital audio stream, and sends the stream to the server with a voice-command event type and context indicating the currently selected product. Server receives the audio stream and uses a speech recognition module to convert the audio samples into a text transcription as intermediate output. Server processes the transcription as input to a natural-language parsing module, performs tokenization and pattern matching for colors, materials, dimensions, and style descriptors, and updates the structured product specification fields accordingly. Server outputs an updated specification containing the recognized values (dark gray, fabric, width 200 cm, depth 90 cm, modern design, comfortable for three people) and logs the recognized utterance for subsequent prompt sentence generation.

### Step 6:

Server receives the updated structured product specification as input and constructs a standardized prompt sentence by inserting specification values into a prompt template.

Server applies attribute mapping rules to convert numerical values and codes into descriptive phrases; for example, “width: 200 cm” becomes “width 200 centimeters,” and a code for a fabric material becomes “fabric.” Server processes the mapped attributes by concatenating them according to the template to generate a prompt sentence such as “Dark gray fabric sofa for a living room, width 200 centimeters, depth 90 centimeters, modern design, comfortable seating for three adults.”

Server outputs this standardized prompt sentence as input to a generative AI model. Server sends the prompt sentence to the generative AI model API and records the prompt and model invocation in a log for traceability.

### Step 7:

Server receives the generative AI model's output sequence as input, where the sequence may contain structured tags or key-value pairs such as “frame_material: hardwood; leg_type: tapered; cushion_firmness: medium; foam_density: 30 kg/m³.” Server parses the output text using predefined tag patterns or a lightweight parser, converting the textual tags into structured fields compatible with the product specification schema. Server processes the AI output by merging the parsed parameters into the structured product specification, overwriting or extending existing fields where appropriate, and validating each new value against design rule information. Server outputs an AI-augmented structured product specification and a set of design parameters that are ready to be used as input for 3D modeling and CAD-based design.

### Step 8:

Server receives the AI-augmented structured product specification as input to the 3D modeling interface module. Server determines, from the product category, which base 3D mesh to load and computes transformation parameters such as scale factors along width and depth, shape blend weights, and material identifiers. Server processes the specification by performing geometric computations on the base mesh, such as scaling vertices along specified axes and applying shape deformation rules determined by style or function. Server assigns material and texture identifiers based on the color and material fields and generates updated three-dimensional model data as output. Server transmits the updated model data to the terminal, or renders frames on the server side and streams a video or frame sequence as output to the terminal.

### Step 9:

Terminal receives updated 3D model data or rendered frames as input and replaces the previous product representation with the new one in the virtual scene. Terminal processes the model data by loading geometry, assigning materials, and updating the rendering pipeline so that lighting and shading correctly represent the new color and material. Terminal outputs an updated 3D preview that the user can view, rotate, zoom, and reposition in the virtual environment. User visually inspects the updated product, walking around it, looking closely at textures, and optionally placing it into a virtual room to check its fit with other virtual items.

### Step 10:

User, after reviewing the 3D preview, confirms the design by selecting a “Confirm” control in the virtual interface. Terminal sends a confirmation event as input to the server together with the current product identifier and session identifier. Server receives the confirmation input and locks the structured product specification, marking it as finalized for design and manufacturing. Server processes the locked specification by storing it with a version tag and outputs a finalized specification dataset as input to the design processing module.

### Step 11:

Server receives the finalized structured product specification as input to a computer-aided design interface. Server maps each field (dimensions, materials, functional requirements) to CAD parameters and feature definitions, such as sketch dimensions, extrusion heights, and material assignments for parts. Server processes this input by invoking CAD engine functions to generate detailed design data, including three-dimensional solid models for frames, cushions, covers, and other components, and extracts geometry for each part. Server outputs a set of detailed CAD models and parts list data (bill of materials) listing components, quantities, materials, and key dimensions.

### Step 12:

Server receives the detailed CAD models and parts list data as input to a process planning module. Server reads facility information and load information, including machine capabilities and current scheduling data, as additional input. Server processes these inputs by running a scheduling algorithm that determines an operation sequence (cutting, forming, assembly, inspection) and assigns each operation to a specific machine and time window.

Server outputs manufacturing process plan data specifying operation order, assigned equipment, and planned start and end times for each step, as well as machine-level instructions and control parameters where applicable.

### Step 13:

Server receives the manufacturing process plan data as input to a manufacturing control module. Server transmits machining programs (e.g., tool paths) and control parameters (e.g., speeds, pressures, temperatures) to manufacturing equipment controllers. Server processes manufacturing state information received from the equipment as input, such as operation started, operation completed, or error codes, and compares actual states with the process plan.

Server outputs updated process plan data if rescheduling is needed, and sends revised control commands to alternative machines or adjusted time slots to maintain overall throughput and reduce bottlenecks.

### Step 14:

Server detects completion of all manufacturing operations for a product from manufacturing state information as input. Server retrieves packaging information and transportation conditions, and processes these inputs to determine package dimensions, required protective materials, and shipping constraints. Server generates shipment information as output, including a destination, selected carrier, route, and tracking identifier, by communicating with external logistics services. Server sends delivery status information derived from the shipment information to the terminal, and optionally to other user-facing devices, as output notifications.

### Step 15:

User views delivery status information on the terminal, such as “in production,” “shipped,” or “delivered.” Terminal receives the status updates as input from the server and renders a corresponding user interface display showing the current state of the order and tracking details. Terminal outputs an updated status display in the virtual environment or on a conventional screen, completing the interaction chain initiated by the original prompt sentence and generative AI model processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented configuration and design systems for customized products generally accept only explicit specification inputs from users and perform fixed processing flows, such as generating static options, rendering simple previews, and passing selected options to downstream design and manufacturing modules. These systems typically treat the user as a passive provider of parameters and do not adapt their internal processing logic or user interface behavior based on how the user actually interacts with the system. As a result, conventional systems exhibit several technical limitations that negatively impact system performance and resource utilization. First, conventional systems do not exploit multimodal interaction data, such as facial images, voice signals, and operation logs, to estimate a user's internal state. As a consequence, the systems are unable to detect situations in which the user is confused, indecisive, or overloaded by the number and complexity of options. The systems therefore continue to present a static or excessive number of candidate specifications and complex user interface screens regardless of the user's state. This increases the number of interaction rounds, causes repeated regeneration of options, and leads to inefficient usage of computational resources, network bandwidth, and storage in the server environment. Second, in existing systems that employ generative AI models, prompt sentences for such models are typically constructed in a fixed, template-based manner that only reflects the explicit specification parameters. These systems do not dynamically adjust the prompt sentences based on real-time emotion estimation or interaction patterns. As a result, the generative AI model often produces candidate specifications that are either too numerous, too detailed, or not sufficiently aligned with the user's current level of understanding and decision readiness. This misalignment leads to unnecessary re-invocations of the generative AI model, redundant 3D model generation, and increased server-side processing load. Third, conventional systems do not tightly integrate the dynamically generated product specification candidates, three-dimensional previews, and downstream detailed design and manufacturing planning in a feedback-controlled manner. In particular, the systems do not use the emotion-aware prompt construction and user interface control as a mechanism to converge quickly to a final specification that is suitable for automated handover to computer-aided design and process-planning components. As a result, the transition from high-level specifications to manufacturable, machine-readable design data is often manual, fragmented, and error-prone, increasing processing latency and reducing throughput. From a computer-technology perspective, these limitations manifest as inefficient use of server-side processors and storage systems, excessive invocation of generative AI inference routines, redundant three-dimensional modeling computations, and suboptimal scheduling and allocation of manufacturing and delivery resources. Consequently, there is a need for an improved computer-implemented system that systematically collects multimodal user interaction data, estimates user emotion states, and dynamically controls both generative AI model prompting and user interface rendering in order to accelerate convergence to a final specification, reduce computational waste, and enhance the overall performance and scalability of the configuration-to-manufacturing pipeline.

The specific processing by the specific processing unit 290 of the data processing device 12 in Example 2 is realized by the following means.

The present invention provides a server comprising a processor and a memory storing instructions which, when executed by the processor, cause the processor to acquire, from a remote terminal, product specification information and natural language instruction information entered by a user, estimate an emotion state of the user based on facial image information, audio information, and operation-history information transmitted from the terminal, construct a generation prompt sentence based on the product specification information and the emotion state, input the generation prompt sentence into a generative AI model to obtain a plurality of pieces of product specification candidate information, generate three-dimensional shape data and display data of a product for each of the pieces of product specification candidate information, provide three-dimensional previews based on the three-dimensional shape data and the display data to the terminal, dynamically control contents of the generation prompt sentence and a display mode of a user interface on the terminal based on the emotion state and the product specification candidate information, acquire final product specification information confirmed by the user based on the three-dimensional previews, generate detailed design information and part information based on the final product specification information, generate manufacturing process plan information based on the detailed design information, the part information, and manufacturing facility information, control manufacturing equipment based on the manufacturing process plan information while managing manufacturing progress information, and generate delivery status information based on shipping information and delivery route information and provide the delivery status information to the terminal. This enables the computing system to adapt the behavior of the generative AI model and the user interface to the user's real-time emotion state, reduce unnecessary candidate generation and three-dimensional modeling computations, shorten the number of interaction cycles required to reach a manufacturable final specification, and thereby improve overall processing efficiency, scalability, and responsiveness of the end-to-end computer-implemented design and manufacturing pipeline.

The term “terminal” refers to an information processing apparatus, such as a handheld device, computing device, or display device, operated by a user and including at least an input interface, a display interface, a communication interface, and optionally an image capture unit and an audio capture unit, which is configured to send user inputs and sensor data to a server and to present information received from the server. The term “user” refers to a human operator of the terminal who inputs product specifications, issues natural language instructions, views three-dimensional previews, and confirms final product specifications through interaction with the system. The term “specification information” refers to information representing desired attributes of a product, including at least category, use, size, color, material, shape, and functional requirements, expressed in structured form or derived from natural language input. The term “instruction information in a natural language” refers to a sequence of words or utterances in a human language, such as spoken or typed sentences, that expresses a user's requirements, preferences, constraints, or modification requests regarding a product specification. The term “input interface” refers to a hardware and software combination, including a communication interface, an application interface, and associated protocols, that enables the server to receive specification information, natural language instruction information, facial image information, audio information, and operation-history information from the terminal. The term “facial image information” refers to image data or video frame data including at least a face region of the user, captured by an image capture unit of the terminal and transmitted to the server for analysis. The term “audio information” refers to digitized audio data representing the user's speech or vocal expressions, captured by an audio capture unit of the terminal and transmitted to the server for speech recognition and emotion analysis. The term “operation-history information” refers to logged interaction data generated on the terminal, including at least touch events, navigation events, timing information, option selection counts, and screen dwell times, which indicate patterns of user operation. The term “emotion state” refers to an estimated internal state of the user, including at least labels representing emotional conditions such as satisfaction, indecision, burden, confusion, or frustration, and optionally a numerical intensity value associated with each label. The term “emotion recognition process” refers to a computation that takes facial image information, audio information, and operation-history information as input and outputs the emotion state by using at least one of image analysis, audio analysis, and operation-pattern analysis implemented with machine learning or statistical models. The term “generation prompt sentence” refers to a text instruction, expressed in a natural language or a semi-structured language, constructed by the server and provided as input to a generative AI model, the text instruction specifying at least the current product specification information, constraints, desired number of candidate specifications, output format, and optionally the user's emotion state. The term “generative AI model” refers to a computational model, such as a machine learning model or neural network model, configured to generate product specification candidate information or design information as output in response to a generation prompt sentence as input. The term “product specification candidate information” refers to one of a plurality of alternative sets of product specifications generated by the generative AI model, each set including at least parameters related to product structure, dimensions, materials, colors, and functions, and being suitable for evaluation by the user. The term “three-dimensional shape data” refers to data representing a three-dimensional geometric structure of a product, including at least vertex data, mesh data, or parametric shape definitions, which can be processed by a rendering engine or modeling engine. The term “display data” refers to data used for visual presentation of a product, including at least material attributes, color attributes, texture information, lighting parameters, and camera parameters, which are associated with the three-dimensional shape data. The term “three-dimensional preview” refers to a visual representation of the product in a three-dimensional form displayed on the terminal, generated from the three-dimensional shape data and the display data, and configured to be interactively manipulated by the user. The term “three-dimensional modeling function” refers to a software function or module that accepts product specification candidate information as input, applies the corresponding parameters to a template or parametric model, and outputs three-dimensional shape data and display data suitable for rendering. The term “user interface” refers to a set of visual and interactive components presented on the terminal, including at least screens, buttons, selection lists, sliders, and text areas, through which the user views information and provides input to the system. The term “display mode of a user interface” refers to a configuration of the user interface, including at least screen layout, number of options shown, level of detail of explanatory text, arrangement and emphasis of input components, and navigation structure. The term “final product specification information” refers to a definitive set of product specifications selected and confirmed by the user after reviewing one or more three-dimensional previews and optionally issuing modification instructions. The term “design process” refers to a computational process in which the server transforms final product specification information into detailed design information and part information, optionally by using a generative AI model and a computer-aided design interface. The term “detailed design information” refers to data describing the structure and geometry of a product at a level suitable for manufacturing, including at least dimensions, tolerances, material thicknesses, and assembly relationships between parts. The term “part information” refers to data describing individual components of a product, including at least part names, identifiers, dimensions, material types, and quantities, typically organized as a parts list or bill of materials. The term “manufacturing facility information” refers to data describing resources available for manufacturing, including at least manufacturing equipment, production lines, worker capacities, and operational constraints. The term “manufacturing process plan information” refers to data representing a planned sequence of manufacturing operations for producing the product, including at least operation order, required equipment, required time, and resource allocations. The term “process planning process” refers to a computational process that transforms detailed design information, part information, and manufacturing facility information into manufacturing process plan information by applying scheduling, optimization, or rule-based algorithms. The term “manufacturing equipment” refers to physical machines, tools, or automated systems used to perform manufacturing operations, including at least cutting, forming, assembling, or finishing operations. The term “manufacturing management process” refers to a computational process that controls manufacturing equipment according to manufacturing process plan information, monitors manufacturing progress, records execution data, and updates manufacturing status. The term “shipping information” refers to data related to the shipment of the manufactured product, including at least shipment identifiers, shipment dates, and destination information. The term “delivery route information” refers to data describing a route or logistics path for delivering the product to a recipient, including at least carrier information, transit steps, and expected delivery times. The term “delivery status information” refers to data indicating a current state of delivery of the product, including at least shipment status, tracking numbers, estimated delivery dates, and delivery completion status, which is generated by the server and provided to the terminal.

In the following embodiments, a server, a terminal, and a user cooperate to implement the claimed system. The embodiments are presented as examples and do not limit the scope of the claims. Server executes the main computational processes of the system. Server includes at least one processor, a main memory, a non-volatile storage device, a network interface, and optionally a graphics processing unit. Server operates on a general-purpose operating system, such as a server-oriented operating system, and executes middleware including a web or application server and a relational database management system. Server stores and executes software modules that implement emotion recognition, prompt sentence construction, generative AI model inference, three-dimensional modeling, design generation, process planning, and manufacturing management. Terminal operates as a user-side interface device. Terminal is a handheld or desktop information processing device such as a smartphone, tablet, or personal computer, and includes a touch-sensitive display, an input device, an image sensor, a microphone, a local storage, and a communication interface. Terminal operates on a mobile or desktop operating system and executes a dedicated application or a browser-based client. Terminal uses a three-dimensional rendering library or engine, such as a WebGL-based library or a game engine, to display three-dimensional previews. User operates the terminal to input product specifications, to provide natural language instructions, to inspect three-dimensional previews, and to confirm a final specification. Server stores user session data, specification data, emotion-state data, prompt sentences, model outputs, three-dimensional model parameters, design data, and manufacturing data in structured form in a database system. Server uses a relational data schema including tables for sessions, users, specifications, emotion states, prompts, candidate specifications, three-dimensional models, design details, parts lists, manufacturing resources, process plans, and delivery statuses. Each record is linked via identifiers such as session identifiers, candidate identifiers, and product identifiers. Server executes an emotion recognition module that processes facial image information, audio information, and operation-history information. Server uses an image analysis pipeline based on a convolutional neural network architecture. In one embodiment, server uses a convolutional network with multiple convolutional layers, pooling layers, and fully connected layers trained to classify facial expressions into categories such as joy, confusion, dissatisfaction, and concentration. Server applies image preprocessing, including resizing to a fixed resolution, normalization of pixel values, and face-detection bounding-box cropping using an image-analysis library. Server converts preprocessed images into tensors and feeds them to the convolutional network to obtain probability distributions over emotion labels. Server uses an audio analysis pipeline for emotion recognition. Server extracts acoustic features such as Mel-frequency cepstral coefficients, energy, pitch statistics, and spectral flux from audio information using an audio-processing library. Server feeds these features to a neural network or gradient-boosting model trained to classify vocal emotion states such as calm, hesitant, frustrated, or excited. Server combines facial-expression scores and vocal-emotion scores with operation-history features such as tap interval statistics, back-navigation frequency, and option-switch counts. Server uses a fusion model, for example a small feed-forward neural network, that takes concatenated feature vectors from multiple modalities and outputs an integrated emotion state including an emotion label and an intensity score. Server trains the emotion recognition models beforehand using supervised learning on labeled multimodal datasets. Server uses a loss function such as cross-entropy loss for classification of emotion labels and uses gradient-based optimization with backpropagation to update the weights of the neural networks. Server optionally performs data augmentation during training, such as random cropping and flipping for facial images and time-shifting or noise injection for audio signals, to improve generalization and robustness. Server stores trained model weights in a model repository and loads them at runtime for inference. Server constructs generation prompt sentences for a generative AI model based on structured specification information and emotion-state information. Server receives specification information in structured format including product category, use case, size, color, material, and functional requirements, and receives emotion state including degrees of indecision, burden, and satisfaction. Server executes a prompt-construction module that applies explicit rules to select template phrases and to adjust conditions in the prompt sentence. Server uses templates that specify required output format, number of candidate options, and emphasis between performance and design. Server adjusts the number of requested candidate specifications in the prompt according to the emotion state. When server estimates that the user is indecisive or burdened, server configures the prompt sentence to request fewer representative options, and explicitly instructs the generative AI model to produce a small number of easily comparable candidates. When server estimates that the user is highly satisfied and close to decision, server configures the prompt sentence to request only slight variations or a single refinement candidate. In one embodiment, server generates a prompt sentence such as: “The user wants red running sneakers. The specification from the user is ‘red running sneakers, size 26 centimeters, breathable mesh material.’ The user is somewhat indecisive and feels burdened when too many options are shown. Based on the following conditions, generate exactly three representative product specification options that balance performance and design and are easy to compare. Conditions: use=running, base color=red, size=26 cm, upper material=breathable mesh. For each option, specify midsole and outsole materials and thickness, cushioning level, durability, grip performance, and overall design style. Present the output in a concise, structured format.” In another embodiment, server generates a prompt sentence for a backpack such as: “User input: ‘black leather backpack, capacity 20 liters, water-resistant.’ The user prefers a simple design and has not specified detailed features. Based on this information, generate three detailed backpack specification options that balance functionality and aesthetics. For each option, include number of pockets, type of fasteners, shoulder-strap width, back cushioning structure, water-resistance level, and approximate weight.” In yet another embodiment, server generates a prompt sentence for furniture such as: “The user specified ‘wooden desk for home office, width 120 centimeters, depth 60 centimeters, dark-brown finish.’ The emotion engine indicates that the user is indecisive and feels burdened by choosing detailed options. To reduce the user's burden, generate three desk specification options categorized into minimal, classic, and modern styles. For each option, include presence or absence of drawers, desktop thickness, leg shape, cable-management features, and a short comment on compatibility with a typical office chair.” Server executes a generative AI model that receives the prompt sentence as input and outputs product specification candidate information. Server uses a large language model architecture composed of multiple transformer layers with self-attention and feed-forward sublayers. Server invokes the generative AI model through an internal inference endpoint running on a separate inference server or on the same server equipped with an accelerator. Server sends tokenized prompt sentences to the model, receives generated token sequences, and decodes them into textual descriptions or structured output formats. Server trains or fine-tunes the generative AI model on domain-specific data including product descriptions, designs, and engineering constraints. Server employs a supervised fine-tuning phase to align model outputs with desired fields and output formats, and optionally a reinforcement learning phase with human or automated feedback to penalize vague, inconsistent, or overly long outputs. Server uses a loss function such as cross-entropy loss over token sequences, and updates model weights using gradient descent variants with adaptive learning rates. Server constrains generation using decoding strategies that limit output length and enforce specific section headers or field names, thereby reducing parsing errors and improving machine readability. Server parses outputs from the generative AI model using a post-processing module that detects field labels and values, resolves units, and maps free-text expressions into structured attributes. Server rejects or corrects inconsistent outputs using rule-based checks, such as verifying that sizes fall within allowable ranges and that material types match allowed lists. This structured specification candidate information is stored in database tables that associate each candidate with its originating session and prompt sentence. Server generates three-dimensional shape data and display data for each candidate specification by controlling a three-dimensional modeling engine. In one embodiment, server uses a general-purpose three-dimensional content creation engine that supports headless operation and scripting, such as a three-dimensional creation software with a scripting interface. Server loads a parametric template model for the product type, such as a base shoe model, and applies candidate parameters including length, width, midsole thickness, outsole thickness, and material assignments to adjust the model geometry. Server uses a parametric representation in which key dimensions are controlled by named parameters stored in a configuration file or script. Server sets these parameters via an application programming interface, and invokes geometric operations such as scaling, extrusion, and boolean union to form the final shape. Server exports the resulting mesh to a standard three-dimensional file format such as a polygonal mesh format or a scene description format. Server also generates material definitions including color values, roughness, metallic properties, and texture maps as part of the display data. Server stores generated three-dimensional files in a storage subsystem accessible through uniform resource locators. Server registers metadata about each three-dimensional model, including candidate identifier, path, and preview text, in the database. Server transmits the three-dimensional model locations and metadata to the terminal over a secure communication channel. Terminal downloads three-dimensional assets and uses a rendering engine such as a WebGL-based library or a cross-platform engine to display interactive three-dimensional previews. Terminal uses a graphics processing unit to execute vertex and fragment shaders that transform and shade the three-dimensional geometry. Terminal maps user interactions, such as drag, pinch, and tap gestures, to camera transformations and object rotations. Terminal updates the rendering in real time, enabling the user to inspect the product from multiple angles and zoom levels. This real-time rendering offloads computation from the server and enables efficient visualization across various devices. User inspects three-dimensional previews and provides feedback by selecting preferred candidates and issuing additional natural language requests. For example, user may say “I want the sole thicker” or “I prefer a lighter design.” Server receives this feedback, updates specification information, and constructs new prompt sentences that describe both the current specification and the user's request. Server outputs refinement prompt sentences such as: “Current specification: use=running, base color=red, size=26 centimeters, upper=breathable mesh, midsole thickness=25 millimeters EVA, outsole=rubber focused on grip. The user requests: ‘I want the sole thicker but do not want to lose stability.’ Based on this, generate exactly one updated specification that increases midsole thickness within a reasonable range while maintaining running stability. Clearly indicate the new midsole thickness and any other changed parameters. Keep all other parameters as close as possible to the original.” Server uses the generative AI model to generate refined specifications, validates changes, and regenerates three-dimensional models. By iteratively refining with emotion-aware prompts and interface control, server reduces the number of cycles required to converge on a final specification, thereby reducing the total number of generative model calls and three-dimensional modeling executions. Server generates detailed design information and part information for the final specification using a combination of generative AI-based parameter generation and computer-aided design integration. Server constructs a design prompt sentence that instructs the generative AI model to output manufacturing-level parameters, such as: “For the following final running shoe specification, generate detailed design information required for manufacturing. Specification: size=26 centimeters, use=running, upper=breathable mesh in red, midsole thickness=28 millimeters made of EVA, outsole=high-grip rubber. Output: dimensions of each part (sole, upper, insole, laces), recommended material thickness and hardness for each part, a summarized assembly sequence, and a complete parts list. Format the output as a structured description that can be mapped to CAD parameters.” Server maps generative outputs to fields expected by a CAD application programming interface. Server uses a CAD system that exposes parameterized feature definitions and supports programmatic creation of sketches, extrusions, and assemblies. Server calls CAD functions to create three-dimensional parameterized parts and assemblies, and exports fabrication-ready models and technical drawings. Server generates manufacturing process plan information by executing a process planning engine that uses optimization algorithms. Server models manufacturing resources and operations as graph structures and uses scheduling algorithms, for example constraint-based solvers or mixed-integer linear programming solvers, to compute operation sequences, assignments to machines, and time windows. This planning engine takes into account processing times derived from part complexity and material, machine capabilities, and desired due dates, and outputs an optimized or near-optimized plan. Server controls manufacturing equipment through a manufacturing management interface, transmitting instructions encoded in formats compatible with production controllers. Server monitors status signals from machines, such as operation completion signals and error codes, and updates manufacturing progress records. Server also coordinates packing and shipping by integrating with logistics systems, generating tracking codes, and maintaining an updated delivery status record. The described system produces several technical effects that go beyond mere automation of human tasks. By using multimodal emotion recognition and dynamic prompt sentence construction, server reduces unnecessary generative AI model invocations and redundant three-dimensional modeling. This yields improved processing efficiency, lower processor utilization, and reduced network traffic between server and terminal. By adapting the number and complexity of options to the user's state, server reduces rework cycles and data volume stored in databases for abandoned options. By structuring generative AI outputs into machine-usable formats and integrating them directly into three-dimensional modeling and CAD workflows, server reduces manual data re-entry and error-prone translation steps, thereby improving data consistency and reducing design errors. By using optimization-based process planning tied to generative design outputs, server improves utilization of manufacturing resources and shortens overall production time. The use of specific neural network architectures, feature extraction procedures, and scheduling algorithms constitutes an improvement to computer technology itself. Server uses non-conventional data flows in which emotion estimation directly influences prompt construction parameters, such as requested number of candidates, required output fields, and tone of the prompt, which in turn changes the behavior of the generative model in a targeted manner. This feedback loop between user interaction data, generative model prompting, and interface adjustment is implemented as a technical control strategy for managing computational resources and data throughput in a distributed system. In alternative embodiments, server may use different neural-network architectures for emotion recognition, such as recurrent networks or attention-based models, or may employ different three-dimensional modeling engines or CAD systems. Server may also execute generative models locally or via external services, so long as server maintains control over prompt sentence construction and output post-processing. Terminal may be implemented as an augmented-reality or virtual-reality device equipped with head-mounted displays, and three-dimensional previews may be presented as immersive environments, while still executing the same logical processes for specification generation and refinement. In all embodiments, server, terminal, and user cooperate through the described modules and data flows to realize a system in which specification information, emotion-state information, prompt sentences for a generative AI model, three-dimensional models, design data, and manufacturing plans are tightly integrated. This integration ensures that the system not only assists human decision-making but also improves the operation of the underlying computing infrastructure by reducing computational redundancy, improving data management, and enabling efficient control of physical manufacturing equipment.

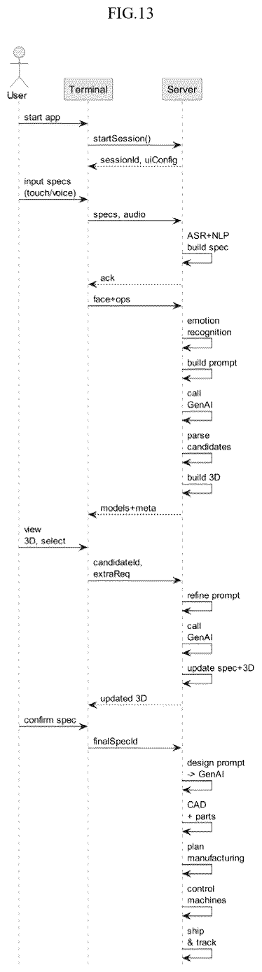

The following describes the processing flow using FIG. 13.

### Step 1:

User operates the terminal to start a configuration session. Terminal receives a launch event from the operating system and initializes a dedicated application or browser client. The input is an application start request and internal configuration data. Terminal generates a session start message that includes a terminal identifier, an application version, and device capability information. Terminal sends this message to the server via a secure communication protocol and outputs a structured request packet.

### Step 2:

Server receives the session start request from the terminal. Server parses the request packet as input, extracts the terminal identifier, application version, and device capability information, and performs a data-processing operation that includes validating version compatibility and generating a new session identifier. Server writes a new session record into a database, storing the session identifier, terminal identifier, and timestamps. The output is a response object containing the session identifier and initial user-interface control parameters such as maximum option count and explanation mode. Server sends this response to the terminal.

### Step 3:

Terminal receives the session identifier and initial user-interface control parameters. Terminal uses the response object as input and updates a local session manager that stores the session identifier in memory. Terminal performs a data-processing operation that maps the received control parameters to a user-interface layout configuration. Terminal generates an initial specification input screen with interactive components for choosing product category, color, size, and use case, and outputs the rendered screen on the display.

### Step 4:

User inputs initial product specifications through the terminal. Terminal receives touch events and gesture events as input, including tap coordinates, selected component identifiers, and timestamps. Terminal performs data-processing operations that update internal state variables representing the current selection of category, color, size, and use case. Terminal outputs structured preliminary specification data and an updated on-screen presentation that visually indicates the current selections.

### Step 5:

User issues a natural language description using voice input. Terminal receives a voice-input button press as input and activates the microphone. Terminal samples the analog audio signal from the user, converts it to digital audio data using the operating system's audio APIs, and encodes it in a selected audio format. The output is a binary audio file or audio buffer.

Terminal associates this audio data with the current session identifier and preliminary specification data, and sends a combined request containing specification data and audio data to the server.

### Step 6:

Server receives the preliminary specification data and audio data from the terminal. Server uses the audio data as input to a speech-recognition engine. Server performs audio-preprocessing operations such as resampling, noise reduction, and feature extraction, and then executes an automatic speech-recognition model to convert the audio into natural-language text. The output is a text string representing the user's spoken description. Server combines this text with the preliminary specification data as input to a natural-language processing module. Server performs tokenization, part-of-speech tagging, and entity extraction to derive structured specification information, such as category, use case, color, size, and material. The output is a structured specification object stored in the database.

### Step 7:

Terminal collects facial image information and operation-history information during user interaction. Terminal receives user-permission status and camera activation events as input.

Terminal captures facial images using an image sensor at periodic intervals, resizes and compresses the images, and logs them in memory. Terminal simultaneously records operation-history data such as tap frequency, back-button use, and screen dwell times.

Terminal performs data-packaging operations that bundle facial images and operation logs into a transmission packet. The output is a multimodal interaction dataset, which terminal sends to the server associated with the session identifier.

### Step 8:

Server performs emotion recognition based on the multimodal interaction dataset.

Server receives facial image data and operation-history data as input. Server processes facial images by applying image decoding, resizing, and normalization, and then executes a convolutional neural network to classify facial expressions. Server extracts features from operation-history data, such as average tap interval and number of navigation reversals, and inputs them to an operation-pattern classifier. Server optionally uses audio emotion features, if available, as additional input. Server performs a fusion operation that concatenates or weights features from all modalities and passes them through a fusion neural network. The output is an emotion state that includes at least an emotion label such as “indecisive” or “satisfied” and intensity values. Server stores the emotion state in the database.

### Step 9:

Server constructs a generation prompt sentence for a generative AI model. Server uses the structured specification object and emotion state as input. Server performs a data-processing operation that selects a prompt template and fills template fields with current specification values and emotion descriptors. Server adjusts the number of requested candidate specifications, the required attributes, and the guidance text according to the emotion intensity. The output is a complete natural-language prompt sentence, for example: “The user wants red running sneakers. The specification from the user is ‘red running sneakers, size 26 centimeters, breathable mesh material.’ The user is somewhat indecisive and feels burdened when too many options are shown. Based on the following conditions, generate exactly three representative product specification options that balance performance and design and are easy to compare. Conditions: use=running, base color=red, size=26 cm, upper material=breathable mesh. For each option, specify midsole and outsole materials and thickness, cushioning level, durability, grip performance, and overall design style. Present the output in a concise, structured format.” Server logs this prompt sentence and sends it as input to the generative AI model.

### Step 10:

Server executes the generative AI model to obtain product specification candidate information. Server tokenizes the prompt sentence and feeds token sequences into a generative AI model, such as a transformer-based large language model. Server uses model parameters, including attention weights and feed-forward layer weights, to compute output token distributions. Server decodes output tokens into text that describes multiple candidate specifications. Server performs parsing and validation of the generated text to extract structured candidate records, checking for completeness and constraints. The output is a set of product specification candidate objects stored in the database and associated with the session identifier.

### Step 11:

Server generates three-dimensional shape data and display data for each product specification candidate. Server receives the candidate specification objects as input and extracts geometric parameters such as overall length, width, sole thickness, and component dimensions, and aesthetic parameters such as color and material type. Server calls a three-dimensional modeling engine via a scripting interface, setting parametric values on a template model and executing geometric operations like scaling, extrusion, and mesh modification. The output is three-dimensional shape data in a mesh or parametric format, as well as material and appearance data. Server exports these into three-dimensional files and material configuration files, stores them in a file repository, and records uniform resource locators in the database.

### Step 12:

Server prepares preview data and sends it to the terminal. Server uses the uniform resource locators for three-dimensional files and candidate descriptions as input. Server constructs a preview dataset that includes, for each candidate, a candidate identifier, a model file location, a summarized explanation, and metadata for display ordering. The output is a preview response packet. Server transmits this packet to the terminal via the communication interface.

### Step 13:

Terminal renders three-dimensional previews and presents them to the user. Terminal receives the preview response packet as input and downloads three-dimensional model files specified by the uniform resource locators. Terminal uses a rendering engine to load vertex, index, and material data into the graphics processing unit. Terminal maps user interaction events such as swipe, drag, and pinch gestures to camera position, orientation, and zoom level. Terminal performs continuous rendering of three-dimensional previews and overlays explanatory text for each candidate. The output is an interactive three-dimensional display that the user can manipulate to inspect different specification options.

### Step 14:

User selects a preferred candidate and optionally issues additional natural language modification requests. Terminal receives selection events such as taps on candidate thumbnails and records the corresponding candidate identifier as input. Terminal also captures additional user voice or text input for refinement, such as “I want the sole thicker but not heavier.” Terminal packages the selected candidate identifier and any additional natural-language data into a refinement request packet. The output is a refinement request that terminal sends to the server.

### Step 15:

Server refines the product specification based on the selected candidate and additional user request. Server receives the refinement request packet as input and retrieves the selected candidate specification from the database. Server processes any attached audio by performing speech recognition, converting it to text. Server merges the text of the user's new request with the previously selected specification, and constructs a new refinement prompt sentence that includes current parameters and explicit change instructions. The output is a refinement prompt sentence, for example: “Current specification: use=running, base color=red, size =26 centimeters, upper=breathable mesh, midsole thickness=25 millimeters EVA, outsole=rubber. The user requests: ‘I want the sole thicker but do not want to lose stability.’ Based on this, generate exactly one updated specification that increases midsole thickness within a reasonable range while maintaining running stability. Clearly indicate the new midsole thickness and any other changed parameters. Keep all other parameters as close as possible to the original.” Server sends the refinement prompt sentence to the generative AI model and obtains an updated specification, then executes the same three-dimensional modeling and preview preparation operations as previously. The output is an updated candidate specification and an updated three-dimensional model, which server sends to the terminal.

### Step 16:

User confirms a final product specification. Terminal receives the updated three-dimensional preview as input and renders it. User inspects the refined product and operates a confirmation control on the terminal. Terminal records this confirmation event and the identifier of the confirmed specification. Terminal constructs a final-confirmation message that includes the session identifier and confirmed specification identifier. The output is a final specification confirmation request transmitted to the server.

### Step 17:

Server generates detailed design information and part information for the final specification.

Server receives the final specification confirmation request as input and reads the confirmed specification from the database. Server constructs a design prompt sentence that describes the final specification and requests manufacturing-level data. Server sends this design prompt sentence to the generative AI model to obtain detailed dimensional recommendations, material thicknesses, assembly steps, and a parts list. Server parses the output into a structured design record and a parts record. Server then maps this data to a computer-aided design system by invoking application programming interface calls that create and parameterize three-dimensional parts and assemblies. The output is detailed design information, part information, and corresponding CAD models stored in a design repository.

### Step 18:

Server generates manufacturing process plan information. Server uses the detailed design information, part information, and manufacturing facility information as input to a process planning engine. Server models operations, resources, and constraints, and runs a scheduling algorithm or optimization solver to determine an order of operations, assignments to machines, and planned durations. Server performs data computations to resolve conflicts and to minimize makespan or cost. The output is manufacturing process plan information stored as process records and schedule records in the database.

### Step 19:

Server controls manufacturing equipment and manages manufacturing progress. Server transmits control instructions to manufacturing equipment controllers based on the manufacturing process plan information. Server receives status updates and completion signals as input from the equipment and updates manufacturing progress entries in the database by performing timestamping and state transitions for each operation. The output is an up-to-date manufacturing status that reflects which operations are in progress, completed, or delayed.

### Step 20:

Server manages shipping information and delivery status and provides status information to the terminal. Server receives manufacturing completion data as input and generates shipping information including shipping identifiers and planned shipment times. Server obtains delivery route information from a logistics system and computes delivery status information such as current location and estimated delivery time. The output is delivery status information, which server provides to the terminal upon request. Terminal receives this information, processes it into user-interface elements, and displays current manufacturing and delivery status to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional product customization and manufacturing systems that utilize three-dimensional previews or computer-aided design tools are generally configured to process explicit specification inputs, such as color, size, and material, supplied by a consumer through a user interface. In such systems, a processor typically applies relatively simple rule-based logic to map the explicit specification inputs to a three-dimensional preview or to design data, and then passes the resulting data to downstream manufacturing planning components. These systems do not effectively exploit recent advances in generative AI models, nor do they dynamically adapt the overall human-computer interaction based on the consumer's real-time emotional state. As a result, these systems exhibit several technical limitations. First, conventional systems process natural language instructions and multimodal sensor inputs (e.g., voice, gaze, facial expressions, biometric signals, and behavior logs) in separate and loosely coupled pipelines, if they are processed at all. This causes the processor to underutilize information about the consumer's confusion, stress, excitement, or fatigue during the customization process. From the standpoint of computer technology, the processor neither maintains a unified, machine-interpretable representation of the consumer's emotional state nor integrates such representation into the generation of prompts for a generative AI model. Consequently, the system cannot optimize its internal information processing flow and cannot dynamically control the complexity or content of the user interface in a way that reduces cognitive load while preserving expressiveness. Second, in known systems that invoke generative AI or recommendation engines, prompt sentences sent to such engines are typically constructed from static templates that only reflect explicit product attributes (e.g., “sofa, dark gray, 200 cm wide”) without encoding any structured representation of the consumer's emotional state or interaction history. This causes the generative AI model to produce outputs that are weakly aligned with the consumer's latent preferences and comfort level. From a computational perspective, the processor uses a suboptimal interface to the generative AI model: the prompt sentence space is not conditioned on emotional indices, and therefore the generative AI model operates on incomplete context. This leads to inefficient prompt-response cycles, increased need for manual corrections by the consumer, and redundant re-computation of three-dimensional models and design data. Third, conventional systems treat user interface control, three-dimensional model generation, detailed design generation, and manufacturing process planning as largely independent modules. The processor typically does not propagate information derived from emotional state estimation and generative AI outputs into downstream computational stages in a consistent manner. For example, conventional systems do not use the same emotional and specification context both to shape the three-dimensional preview and to constrain the automatic generation of detailed design information and manufacturing process plans. This fragmented processing architecture causes inefficiencies such as repeated data transformations, inconsistent parameter choices across modules, and difficulty in closing the loop between consumer interaction and manufacturing execution. Fourth, traditional systems do not maintain and exploit a structured log of specification information, emotional state transitions, prompt sentences, generative AI outputs, and final consumer selections as training data for subsequent model refinement. As a result, the processor cannot systematically learn which combinations of emotional indices, prompt patterns, and user interface strategies yield better outcomes, such as higher satisfaction or lower abandonment. From the standpoint of computer technology, the processing architecture lacks a feedback loop that automatically updates the parameters of the emotion estimation process and prompt generation process based on accumulated interaction data. This prevents the system from improving its performance over time in an autonomous and data-driven manner. Fifth, existing virtual reality based customization systems, where present, tend to render three-dimensional scenes and accept controller input, but they do not deeply integrate three-dimensional rendering pipelines with emotion-aware control logic. In particular, the processor does not dynamically alter the display mode, guidance content, and the range of customization items displayed in a virtual store in response to machine-estimated emotional states. Instead, the processor applies static user interface layouts and option sets. This results in either overly complex interfaces that overwhelm novice users or overly simplistic interfaces that frustrate expert users, thereby degrading the effectiveness of the underlying computing system as an interactive customization platform. Accordingly, there is a need for a computer-implemented system and processing architecture in which a processor: (i) acquires and fuses multimodal user state data to estimate an emotional state as a machine-interpretable index; (ii) generates prompt sentences for a generative AI model that are jointly conditioned on detailed specification information and the emotional state; (iii) uses the generative AI output as extended information to drive three-dimensional model generation, detailed design generation, and manufacturing process planning in a consistent pipeline; (iv) dynamically controls user interface complexity and content in virtual or non-virtual environments based on the emotional state and the extended information; and (v) logs interaction data to continually refine emotion estimation and prompt generation models. By reorganizing the data flow and processing logic in this manner, the computer system can reduce computational redundancy, improve alignment between generative AI outputs and user needs, and enhance the overall efficiency and robustness of the interactive customization and manufacturing process.

The specific processing by the specific processing unit 290 of the data processing device 12 in Application Example 2 is realized by the following means.

The present invention provides a server comprising a processor configured to acquire instruction information including a natural language input from a consumer and generate or update specification information relating to a product based on the instruction information; to acquire user state data including at least one of voice data, expression data, gaze data, behavior history data, and biometric data of the consumer and to estimate an emotional state of the consumer as a numerical index or a category based on the user state data; to automatically generate a prompt sentence including information relating to product classification, specification conditions, constraint conditions, and the emotional state based on the specification information and the emotional state, to input the prompt sentence to a generative AI model, and to acquire extended information relating to the product from the generative AI model; to generate three-dimensional shape data of an appearance of the product based on the specification information and the extended information, and to generate a three-dimensional preview based on the three-dimensional shape data; to automatically create detailed design information including structural parameters, member configuration, dimensions, tolerances, and functional requirements of the product based on the specification information and the extended information; to automatically generate a manufacturing process plan including allocation of manufacturing equipment and workers, contents of operations in each process, an operation sequence, and a required time based on the detailed design information; to control manufacturing equipment in accordance with the manufacturing process plan to manufacture the product and to cause the manufactured product to be transported to a delivery destination; to dynamically change, based on the emotional state and the specification information, at least one of a display mode of a user interface, guidance content, and a display range of customization items in a virtual space or on a display apparatus; to acquire an execution status of the manufacturing process plan and a delivery status of the product and notify the consumer of the execution status and the delivery status; and to record at least the specification information, the emotional state, the prompt sentence, an output result of the generative AI model, and a final selection result of the consumer, and to update parameters of an emotion estimation process and a prompt generation process based on a record of the information. This enables the server to implement an integrated, emotion-aware computing pipeline in which multimodal user state data and explicit specification inputs are fused into a unified context that conditions prompt sentences for the generative AI model, in which extended information output from the generative AI model is consistently propagated into three-dimensional preview generation, detailed design generation, and manufacturing process planning, and in which user interface control is dynamically adapted based on machine-estimated emotional states, thereby reducing computational redundancy, improving alignment between generated content and consumer needs, and enhancing the efficiency and technical performance of the overall interactive customization and manufacturing system.

The term “consumer” refers to a user who interacts with the system in order to specify, customize, and purchase a product, and whose instructions, behavior, and state are processed by the processor. The term “instruction information” refers to information including at least a natural language input provided by the consumer, and may further include gesture inputs, selection operations, and other interaction data indicating a desired product specification or operation. The term “natural language input” refers to a sequence of words or phrases expressed in a human language, such as spoken utterances recognized by speech recognition or text entered through an input device, which is interpretable by the system to derive specification information or control commands. The term “specification information” refers to data indicating conditions relating to a product, including at least one of product classification, color, shape, dimensions, material, usage, functional requirements, and design style, which are used as input to downstream modeling, design, and planning processes. The term “user state data” refers to data representing a physical, behavioral, or physiological state of the consumer during interaction with the system, including at least voice data, expression data, gaze data, behavior history data, and biometric data. The term “voice data” refers to audio signals captured from the consumer's speech by a sound acquisition apparatus, which are digitized and processed to derive linguistic content or acoustic features indicative of emotional state. The term “expression data” refers to image data or derived feature data representing a facial expression or other visible expression of the consumer, obtained from an imaging apparatus and used to estimate an emotional state. The term “gaze data” refers to data indicating at least a direction of line of sight, a gaze point, or a gaze duration of the consumer, detected for example by an eye tracking apparatus and used to infer interest, confusion, or attention. The term “behavior history data” refers to data representing a sequence of interaction events of the consumer with the system, including at least movement paths, selection operations, cancellation operations, dwell times, and navigation patterns in a virtual or non-virtual environment. The term “biometric data” refers to physiological measurement values associated with the consumer, including at least heart rate, skin conductance, respiration rate, or similar signals, which can be used to infer stress, fatigue, or arousal. The term “emotional state” refers to a machine-interpretable representation of a psychological or affective condition of the consumer, such as confusion, interest, stress, excitement, fatigue, or sense of safety, expressed as a numerical index or a categorical label. The term “prompt sentence” refers to a natural language instruction sequence generated by the processor, which includes information relating to product classification, specification conditions, constraint conditions, and the emotional state, and which is input to a generative AI model to control its output. The term “generative AI model” refers to an artificial intelligence model trained using machine learning, which generates information such as text, parameters, or structural descriptions in response to an input prompt sentence, and which may be implemented as a large language model or similar generative model. The term “extended information” refers to information relating to a product that is output by the generative AI model in response to the prompt sentence, and that complements or refines the specification information, including at least structural parameters, recommended settings, appearance details, and explanatory descriptions. The term “three-dimensional shape data” refers to data describing a three-dimensional geometry of a product, including at least vertex coordinates, surface definitions, and structural relationships suitable for rendering or further design processing. The term “three-dimensional preview” refers to a visual representation of a product generated based on the three-dimensional shape data, which is displayable in a virtual space or on a display apparatus and is used to allow the consumer to visually confirm a customized product. The term “detailed design information” refers to engineering data necessary for manufacturing a product, including at least structural parameters, member configuration, dimensions, tolerances, functional requirements, and part relationships, typically suitable for use in computer-aided design and analysis. The term “manufacturing process plan” refers to plan information defining a sequence and allocation of manufacturing operations, including at least allocation of manufacturing equipment and workers, contents of operations in each process, an operation sequence, and a required time for each operation. The term “manufacturing equipment” refers to machinery and apparatus used to perform manufacturing operations, including at least cutting machines, forming machines, assembly stations, inspection devices, and similar production apparatus. The term “display mode” refers to a configuration of how information, including user interface elements and three-dimensional previews, is visually presented on a display apparatus or in a virtual space, including layout, visual emphasis, level of detail, and interaction affordances. The term “user interface” refers to a collection of input and output elements, including graphical components, textual guidance, and interactive controls, through which the consumer and the system exchange information. The term “guidance content” refers to information presented to the consumer in order to assist operation of the system, including at least instructions, recommendations, hints, and explanatory messages. The term “display range of customization items” refers to a subset of customization parameters or options that are made visible and accessible to the consumer in the user interface at a given time, which can be varied according to the emotional state or context. The term “virtual space” refers to a computer-generated environment, including at least a three-dimensional or pseudo three-dimensional scene, in which product objects, user interface elements, and other virtual entities are displayed and with which the consumer can interact. The term “display apparatus” refers to a device for presenting visual information to the consumer, including at least a head-mounted display, a flat panel display, or a projection apparatus.

The term “execution status of the manufacturing process plan” refers to information indicating a current progress condition of manufacturing operations defined in the manufacturing process plan, including at least a step being executed, a completion state, and timing information. The term “delivery status” refers to information indicating a logistics condition of a manufactured product, including at least shipment initiation, in-transit state, estimated delivery time, and completion of delivery. The term “emotion estimation process” refers to a computation process that converts user state data into an emotional state representation, using at least feature extraction and classification or regression models. The term “prompt generation process” refers to a computation process that generates a prompt sentence based on specification information and an emotional state, using at least template selection, rule-based processing, or machine-learned sequence generation. The term “head-mounted display” refers to a wearable display apparatus configured to be mounted on the head of the consumer and to present visual information, including a three-dimensional preview or a virtual space, to the consumer's eyes. The term “input device” refers to a hardware component used by the consumer to provide interaction signals to the system, including at least a controller, a gesture sensor, a pointing device, or a touch input device. The term “voice input/output device” refers to a hardware component that captures voice of the consumer and/or outputs audio to the consumer, including at least a microphone, a speaker, or a headset. The term “product object” refers to a data entity representing a product in the system, including at least an identifier, associated specification information, and associated three-dimensional shape data, and which may be visualized as a three-dimensional object in a virtual space. The term “store display region” refers to a portion of a virtual space or a display layout that simulates a store environment and includes one or more product objects and associated user interface elements The term “final selection result” refers to information indicating a final choice made by the consumer with respect to a product configuration, including at least a confirmed specification information set and a purchase decision. The term “record” refers to storing, in a storage apparatus or memory, data such as specification information, emotional state, prompt sentence, generative AI output, and final selection result, in a form retrievable for later processing and analysis.

In the following embodiments, a server, a terminal, and a user cooperate to implement the claimed system. The same reference concepts are used throughout, but the invention is not limited to these specific examples.

### A. Overall Hardware and Software Configuration

A server is implemented as an information processing apparatus including at least a central processing unit (CPU), a main memory, a non-volatile storage device such as a solid state drive, a graphics processing unit (GPU) or other hardware accelerator, and a network interface. The server executes a server-grade operating system such as a general-purpose server operating system, and runs application programs implemented for example in a high level language such as a scripting language or a compiled language. The server optionally uses a relational database management system for persistent storage of specification information, user state data, emotional state data, prompt sentences, outputs of a generative AI model, detailed design information, and manufacturing process plans. The server executes software modules including at least: (i) an input processing module, (ii) a multimodal feature extraction module, (iii) an emotion estimation module, (iv) a prompt generation module, (v) an interface module to a generative AI model, (vi) a three-dimensional model generation module, (vii) a design generation module, (viii) a manufacturing process planning module, (ix) a user interface control module, (x) a progress notification module, and (xi) a learning module for updating model parameters. A terminal is implemented as a head-mounted display device or other information processing terminal including a CPU, a GPU integrated into a system-on-chip or provided as a discrete component, a main memory, non-volatile storage, and a network interface such as a wireless communication interface. The terminal is connected to a head-mounted display, one or more input devices such as controllers, a microphone, optionally a camera, and optionally biometric sensors such as a heart rate sensor or a skin conductance sensor. The terminal executes a terminal operating system and a client application implemented on a three-dimensional game engine such as a generic three-dimensional game engine software. The terminal runs a three-dimensional rendering engine, an input management subsystem, a local state synchronization module, and a communication module that exchanges messages with the server via a wired or wireless network. The user wears the head-mounted display, holds the input devices, and interacts with a virtual space rendered by the terminal. The user issues natural language instructions, performs gestures, selects product objects, and confirms purchases.

### B. Acquisition of Instruction Information and Generation of Specification Information

The terminal acquires instruction information from the user by means of voice input and motion input. The terminal captures audio signals from the microphone, digitizes the audio signals into audio frames, and transmits the frames to the server via the network interface. In parallel, the terminal acquires position and orientation data of the head-mounted display and controllers using tracking sensors and an inertial measurement unit exposed by a device software development kit. The terminal detects selection operations and gestures by processing this position and orientation data with the game engine's input management subsystem. The server receives instruction information and associates it with a product object selected by the user. The server uses a speech recognition library or an external speech recognition service to convert audio frames into text. The server applies natural language processing to the text to extract candidate values for specification fields such as color, dimensions, material, usage, and design style. The server combines these values with motion-derived parameters, such as dimension change amounts derived from gestures, to generate structured specification information. The structured specification information is stored in a database record including fields such as product classification, color, width, depth, height, material category, and intended use. By structuring the instruction information in this manner, the server normalizes heterogeneous user inputs into a unified data representation that can be efficiently processed by subsequent modules without repeated parsing.

### C. Acquisition of User State Data and Emotion Estimation

The terminal acquires user state data continuously while the user interacts with the virtual space. When the terminal includes a camera, the terminal captures images of the user's face at periodic intervals and transmits compressed image frames to the server. When the terminal includes an eye tracking function, the terminal generates gaze data, including coordinates of gaze points in the rendered scene and gaze durations, and transmits this data to the server. The terminal also logs user behavior history such as movement paths in the virtual space, dwell times near particular product objects, selection and cancellation events, and menu navigation, and transmits this as behavior history data. If biometric sensors are present, the terminal transmits time series of biometric data such as heart rate values and skin conductance values. The server executes a multimodal feature extraction pipeline implemented using numerical computation libraries. The server transforms raw voice waveforms into acoustic feature vectors such as power spectra and cepstral coefficients. The server processes facial images with an image processing library to perform face detection and cropping, then passes the cropped images to a convolutional neural network that outputs feature vectors representing visible expressions. The server derives behavioral features from the behavior history data, such as counts of product switches, frequencies of cancellations, and distribution of dwell times. The server also normalizes biometric signals by subtracting a baseline and scaling by a variance estimate, thus capturing relative physiological arousal.

The server concatenates these features into a unified feature vector per time window and inputs this vector to an emotion estimation model. In one embodiment, the emotion estimation model is a multi-layer neural network that takes a feature vector as input and outputs continuous values representing emotional indices such as confusion level, interest level, stress level, and excitement level. The neural network may include fully connected layers, rectified linear unit activations, and a final linear or logistic output layer. In another embodiment, the emotion estimation model is a recurrent neural network configured to process sequences of feature vectors and capture temporal dependencies. The server applies a temporal smoothing algorithm such as a moving average filter to the emotional indices to reduce noise. The server then stores the emotional state, including the smoothed indices and optional categorical labels, in association with the corresponding session. By implementing a multi-modal feature pipeline and a machine-learned emotional mapping in this concrete manner, the server can estimate emotional state more accurately and with lower latency than simple rule-based heuristics.

### D. Prompt Generation and Interaction with the Generative AI Model

The server constructs prompt sentences based on the specification information and the emotional state. The server maintains template data structures in memory, each template including segments for product classification, specification constraints, recommended constraints, and emotional context. The server selects a template using rule-based logic that examines the product classification field and the current emotional indices. For example, when the confusion level is above a threshold and interest level is moderate, the server selects a template that emphasizes safety and conservative design. When excitement level is high and stress level is low, the server selects a template that emphasizes bold design and experimentation. The server fills template placeholders with specification information values, and inserts emotionally conditioned sentences based on thresholds or ranges of emotional indices. For example, when confusion is high, the server inserts text such as “the user is confused and wants to avoid making a mistake,” whereas when excitement is high, the server inserts text such as “the user is excited and prefers bold, eye-catching designs.” The server then concatenates these segments into a complete prompt sentence.

Examples of such prompt sentences include: “Design a living room sofa with the following specifications: dark gray fabric, width 200 cm, depth 90 cm, modern style. The user feels confused about choosing a sofa and wants to avoid making a mistake. Propose a simple and calm design that matches many interior styles and avoids flashy shapes and colors. The seat should have medium firmness and a cushion structure that reduces fatigue during long sitting. Provide structural parameters and a short explanation that reassures the user.” “Design a living room sofa with the following base conditions: dark gray fabric, width 200 cm, depth 90 cm. The user is excited about trying new designs and prefers bold, eye-catching furniture. Propose a distinctive modern design that becomes the centerpiece of a living room. Use slim metal legs, add characteristic lines to the armrests and stitching, and consider optional accent colors. Output specific geometric parameters such as backrest angle, leg length and shape, and cushion profile, and provide a description that emphasizes unique style and visual impact.” “Design a pair of running sneakers with the following base conditions: red color, size 26 cm, breathable mesh upper. The user has recently experienced foot fatigue during training and is especially concerned about heel impact and arch support. Propose a structure that increases cushioning and stability, focusing on heel shock absorption and midfoot support. Provide recommended midsole hardness, heel-to-toe drop, outsole pattern, and arch support geometry, and include a concise explanation of how the design reduces fatigue and risk of injury.” The server transmits the prompt sentence to a generative AI model. In one embodiment, the generative AI model is a transformer-based large language model deployed on the same server, using the server's GPU to accelerate matrix multiplication operations. In another embodiment, the server communicates with an external generative AI service via an application programming interface. The server includes in the request the full prompt sentence and optional control parameters such as maximum token length and temperature. The generative AI model receives the prompt sentence and outputs a text response. The response includes detailed proposals for structural parameters, material combinations, design elements, and explanatory reasoning. The server parses the response using deterministic parsing rules and, if needed, a lightweight auxiliary classifier to recognize parameter names and values. The server constructs extended information from the parsed values. For example, the server may extract values such as “backrest height 70 cm,” “backrest angle 105 degrees,” “legs made of metal,” “seat with two layers of foam of different hardness,” and map them into structured fields. By conditioning the prompt sentence on both specification information and machine-estimated emotional state, the server shapes the generative AI computation into a constrained subspace of the model's overall behavior. This improves the relevance of generated parameters, reduces the number of corrective cycles, and therefore reduces computational and communication overhead.

### E. Three-Dimensional Model Generation and Preview Display

The server generates three-dimensional shape data for the product based on the specification information and the extended information. The server invokes a three-dimensional modeling engine that supports parameterized modeling, such as a scriptable modeling environment or a three-dimensional geometry kernel. The server passes parameter values for overall dimensions, component dimensions, angles, and material assignments to the modeling engine. The modeling engine computes vertices, surfaces, and polygon meshes according to predefined rules for the product category. For example, when the product is a sofa, the server calculates frame dimensions from the width, depth, and height, constructs a rectangular frame mesh, extrudes a backrest with the specified height and angle, generates cushion meshes with thickness and contour determined by the extended information, and positions leg meshes with the specified shape and length. The server assigns material identifiers for upholstery, frame, and legs, enabling the terminal to apply textures during rendering. The server exports the three-dimensional shape data in a format suitable for real-time rendering, such as a compact scene description file. The server compresses the data if necessary and transmits it to the terminal. The terminal receives the three-dimensional shape data and loads it into the game engine's asset management system. The terminal creates a scene object representing the customized product, attaches the mesh and material components, and places the object at a location corresponding to the selected virtual display area. The terminal renders the customized product in the head-mounted display and allows the user to rotate, move, and scale the product using controller inputs. The terminal thus provides a three-dimensional preview that directly reflects both specification information and extended information.

By offloading intellectual operations such as structural parameter determination to the server and maintaining a compact geometric representation on the terminal, the system reduces bandwidth usage and rendering overhead while enabling high-fidelity previews.

### F. Detailed Design Generation and Manufacturing Process Planning

The server uses the specification information and the extended information to generate detailed design information. The server invokes a design generation module that interfaces with a computer-aided design engine. The module converts three-dimensional mesh information and parameter values into engineering entities such as solids, reference planes, and constraints. The module then generates drawings and bills of materials. For example, for a sofa, the server calculates cross-section shapes and dimensions for frame beams, determines attachment points for legs and cushions, specifies thickness and layering for cushioning material, and computes fabric cutting patterns. The server encodes this information as detailed design information, including parametric definitions that can be edited if needed. The server uses the detailed design information as input to a manufacturing process planning module. This module executes algorithms that map components and operations to available manufacturing resources. The server reads device capability data from a manufacturing resources database, including maximum workpiece sizes, cycle times, and tooling options. The server then constructs a process graph in which nodes represent operations and edges represent precedence constraints. The server applies a scheduling algorithm, such as a heuristic or optimization-based method, that assigns operations to machines and workers, selects start times, and enforces capacity constraints. In one embodiment, the process planning module solves a mixed integer optimization problem approximating total completion time subject to resource constraints. In another embodiment, the module uses a rule-based heuristic for typical product families. The result is a manufacturing process plan including step identifiers, assigned machines, planned start and end times, and required materials for each step. The server transmits the manufacturing process plan to a manufacturing execution system that controls actual manufacturing equipment. The manufacturing execution system, under control of the server or an associated controller, configures machines by setting, for example, cutting paths, forming parameters, or assembly sequences. As a result, the claimed system extends beyond abstract data manipulation and actively controls physical apparatus to produce a manufactured product in the real world.

### G. User Interface Control and Progress Notification

The server dynamically controls the user interface rendered by the terminal based on the emotional state and the specification information. The server defines UI configuration profiles that specify which customization items are visible, which guidance messages are displayed, and how interface elements are laid out. When the confusion level is high, the server selects a profile that hides advanced adjustments and highlights an “automatic suggestion” function. The server transmits a UI configuration message to the terminal, including flags and parameters indicating visible panels, button emphasis, and optional explanatory text. The terminal receives the configuration and, through the game engine's UI subsystem, shows only basic controls such as color and overall dimensions and displays large, easily selectable recommendation buttons. When excitement and interest levels are high, the server selects a profile exposing detailed customization parameters such as stitching patterns or decorative elements. The terminal receives the configuration and displays additional sliders and controls. The server can also modify UI color schemes or background lighting conditions in the virtual space in response to stress or fatigue indices, and the terminal applies those lighting parameters in the rendering engine. The server obtains execution status of the manufacturing process plan and delivery status from external systems. The server converts the raw status data into user-oriented messages and sends them to the terminal. The terminal renders these messages in a status panel or overlay within the virtual space, thereby allowing the user to see that the product has moved from design to manufacturing, inspection, shipment, and delivery. This integration tightens the connection between the user's virtual customization actions and the physical manufacturing and logistics processes.

### H. Learning and Improvement of Emotion Estimation and Prompt Generation

The server continuously records specification information, emotional states, prompt sentences, outputs of the generative AI model, and final selection results. The server stores this data in logs indexed by session and time. A learning module processes this historical data offline. The learning module extracts training pairs consisting of feature representations (including user state features and context) and target labels such as user satisfaction or acceptance of a proposed design. The server uses these training pairs to update parameters of the emotion estimation model. For example, the server applies a gradient-based optimization algorithm to minimize a loss function measuring the discrepancy between predicted emotional indices and reference labels derived from user behavior (e.g., whether the user reverted changes or abandoned a session). Similarly, the server trains a model to map current specification information and emotional indices to template selection and phrase patterns that yielded high satisfaction in the past, thereby optimizing the prompt generation process. By implementing these learning processes, the server improves the accuracy of emotional state estimation and the quality of prompt sentences over time, resulting in fewer interaction cycles and more efficient use of computational and communication resources.

### I. Technical Effects and Improvements in Computer Technology

The server, by integrating multimodal feature extraction, emotion estimation, prompt generation, three-dimensional modeling, design generation, and manufacturing planning within a single pipeline, improves the operation of the computing system itself. The multimodal emotion estimation model enables the server to prioritize certain user interface updates and to filter irrelevant generative AI outputs, thereby reducing the number of expensive generative AI calls and three-dimensional modeling operations. This reduction in redundant computation leads to lower CPU and GPU utilization and reduces network traffic between the server and the terminal. The prompt generation module, by conditioning prompt sentences on emotional state, constrains the generative AI model to generate outputs that are closer to the user's needs on the first attempt. This reduces the need for iterative refinement, improves the effective throughput of the generative computation, and reduces latency between user input and updated preview. The server's data structures and parameterized modeling also avoid full regeneration of three-dimensional models when only certain parameters change, which further reduces rendering and communication costs. The emotion-adaptive UI control module allows the terminal to display only a subset of customization items when appropriate, which reduces the amount of data the terminal must render and the complexity of event handling, leading to smoother frame rates and more responsive input handling. The coordinated use of emotional indices, structural specification information, and generative AI outputs to drive manufacturing process planning results in consistent parameter choices that reduce discrepancies between virtual models and physical products, thereby decreasing rework and waste. Because the server employs machine-learned models with specific architectures, explicitly defined feature extraction procedures, and defined update rules, and because the output of these models directly controls physical manufacturing equipment and alters the internal processing flow of the computing system, the embodiments go beyond mere automation of human mental steps. The described system modifies how data are structured, how they flow among modules, how network interactions are scheduled, and how physical apparatus are controlled, such that the computer system operates in a technically improved manner with enhanced processing speed, reduced communication overhead, improved prediction accuracy, and more efficient resource usage across computing and manufacturing environments. Multiple variations of these embodiments are possible. For example, the generative AI model may be replaced with a smaller domain-specific generative model, the emotion estimation model may incorporate attention mechanisms or graph-based features, and the manufacturing process planning module may use alternative optimization formulations. The terminal may be a non-immersive display device, and the server may distribute computation across multiple physical machines. These and other modifications are within the scope of the invention so long as the processor performs the core operations of generating specification information and emotional state from user inputs, constructing emotionally conditioned prompt sentences for a generative AI model, obtaining extended information, and using that information to control three-dimensional previews, detailed designs, manufacturing process plans, and user interfaces in an integrated manner.

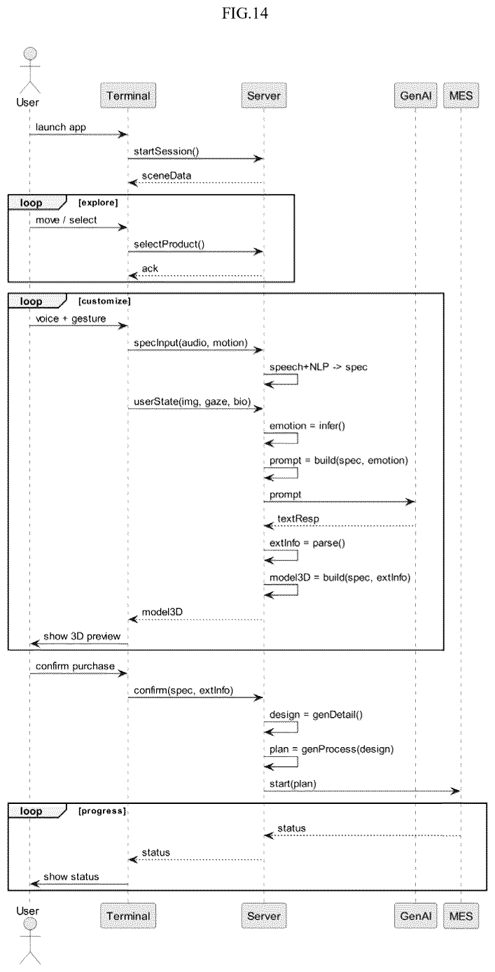

The following describes the processing flow using FIG. 14.

### Step 1:

The terminal initializes a session and connects to the server.

The terminal receives as input a launch command from the user (for example, selecting an application icon) and internal configuration data including a server URL and device identifiers. The terminal uses this input to start a three-dimensional game engine, initialize a head-mounted display, controllers, a microphone, and optionally a camera and biometric sensors. The terminal then generates a session start message containing a user identifier, a terminal identifier, device capability information, and localization settings, and transmits this message via a network interface to the server as output.

### Step 2:

The server authenticates the session and returns virtual store scene data.

The server receives as input the session start message from the terminal. The server validates the user identifier and any authentication token against a user account database, and looks up a corresponding user profile. The server then queries a scene definition repository to retrieve data describing a virtual store, including layout, product object placeholders, and default user interface panel positions. The server stores a session record linking the user identifier and terminal identifier, and generates as output a response message containing authentication status and the virtual store scene definition, which the server sends to the terminal.

### Step 3:

The terminal constructs and displays the initial virtual store.

The terminal receives as input the scene definition from the server. The terminal uses the three-dimensional game engine to instantiate floor meshes, wall meshes, shelving meshes, and product object placeholders at positions specified in the scene definition. The terminal loads base materials and textures from local storage or remote resources and registers collision components on the product placeholders. The terminal then starts a render loop and outputs, to the head-mounted display, a visual representation of the initial virtual store scene.

### Step 4:

The user explores the virtual store using head and controller movements.

The user provides as input physical head motion and controller operations (for example, joystick movements and button presses). The terminal receives this physical input through tracking sensors and an input subsystem and converts it into pose data and movement vectors.

The terminal uses this data to update a camera transform and a virtual avatar position in the scene graph, and then recalculates visible geometry. The terminal outputs updated image frames to the head-mounted display, showing the user's new viewpoint and location in the virtual store.

### Step 5:

The user selects a product object in the virtual store.

The user directs gaze or a controller orientation toward a desired product and actuates a trigger button. The terminal receives as input the trigger event and gaze or controller orientation data. The terminal performs a ray-casting operation from the camera or controller origin into the three-dimensional scene using the game engine's physics functions, and detects an intersection with a product object placeholder. The terminal extracts the intersected product object's identifier and world-space hit position, constructs a product selection event, and transmits this selection event as output to the server.

### Step 6:

The server sets the current product context.

The server receives as input the product selection event from the terminal. The server updates the session record to store the selected product object identifier as the current product. The server queries a product catalog database to obtain base metadata such as category, default dimensions, default materials, and default usage for the chosen product. The server combines these metadata items into initial specification information and stores it in the session as output for use in subsequent processing.

### Step 7:

The user provides natural language instructions and gestures for customization.

The user supplies as input spoken instructions such as “Make this sofa dark gray and set the width to 200 centimeters,” and performs gestures with controllers or hands to indicate dimensional changes. The terminal captures audio via the microphone, converts the analog signal into digital samples, segments the samples into time-windowed audio frames, and encodes them. The terminal reads controller or hand positions over time, computes displacement vectors, and interprets them as provisional parameter changes (for example, width increase). The terminal aggregates the audio frames and provisional parameters into a specification input message, and sends this message as output to the server.

### Step 8:

The server performs speech recognition and extracts textual specification values.

The server receives as input the audio frames and provisional parameter data. The server passes the audio frames to a speech recognition engine, which converts speech waveforms into text. The server then uses a natural language processing module to parse the text and identify entities corresponding to colors, dimensions, materials, and usage (for example, “dark gray,” “width 200 centimeters”). The server maps recognized phrases to structured attribute fields. The server outputs a set of textual attribute candidates corresponding to color, width, depth, material, and similar fields.

### Step 9:

The server merges gesture-derived parameters and textual attributes into specification information.

The server receives as input the textual attribute candidates from the natural language parser and the provisional parameter values from gesture analysis. The server applies resolution rules, for example, giving precedence to explicit numeric values from text while using gesture values to fill missing or approximate attributes. The server computes final numeric dimension values and categorical properties based on this combination. The server outputs consolidated specification information, including fields for product category, color, width, depth, material category, and design style, and stores this specification information in the session state.

### Step 10:

The terminal streams user state data to the server.

The terminal continuously acquires as input multiple types of user state data, such as: facial images captured from a camera, gaze coordinates and fixation durations from an eye-tracking system, biometric values from sensors, and behavior history data from the interaction log (for example, movement paths, dwell times, selection and cancellation frequencies). The terminal time-stamps each data sample, packages the samples into batches, and transmits the batches to the server as output.

### Step 11:

The server computes multimodal features from user state data.

The server receives as input the batches of facial images, gaze logs, biometric signals, behavior history, and optionally voice segments. The server uses an image processing library to detect faces in the images and crop regions of interest, then converts the pixel arrays into feature vectors by passing them through convolutional layers of a pre-trained neural network, yielding expression features. The server processes gaze logs to compute statistics such as per-product fixation time and average saccade frequency. The server processes biometric signals by applying normalization (for example, subtracting baseline and dividing by standard deviation) and extracting features such as mean, variance, and rate of change over a time window. The server processes behavior history by counting events such as product switches and cancellations and computing path length in the virtual space. The server outputs a unified feature vector for each time interval, combining expression, gaze, biometric, and behavior features.

### Step 12:

The server estimates the user's emotional state from the multimodal features.

The server receives as input the unified feature vectors. The server feeds each vector into an emotion estimation neural network implemented with multiple layers of weights and activation functions. The network computes linear transformations and non-linear activations that map the features to continuous emotional indices such as confusion level, interest level, and stress level. The server applies temporal smoothing, such as averaging over a sliding window, to the output indices to reduce transient fluctuations. The server then outputs a current emotional state record, including numerical values and optionally categorical labels, and stores the emotional state in the session.

### Step 13:

The server generates an emotionally conditioned prompt sentence.

The server receives as input the consolidated specification information and the current emotional state. The server selects a prompt template based on the product category and emotional indices, using rule-based logic (for example, if confusion level>threshold, select a conservative template). The server fills template placeholders with specification values such as color, width, depth, material, and usage, and inserts emotional context phrases that describe the user's mental state. The server concatenates the segments into a coherent natural language sequence, and outputs a complete prompt sentence that includes both technical constraints and emotional context.

### Step 14:

The server sends the prompt sentence to the generative AI model and obtains extended information.

The server receives as input the complete prompt sentence from the prompt generation module. The server constructs a request object containing the prompt sentence and optional parameters (for example, maximum tokens), and transmits this request via an application programming interface to a generative AI model. The generative AI model computes a text response representing a detailed proposal, including structural parameters and design justifications. The server receives this response as input and parses it using pattern matching and natural language parsing procedures to extract named parameters and associated values.

The server outputs structured extended information that complements the existing specification information.

### Step 15:

The server generates three-dimensional shape data based on specification and extended information.

The server receives as input the consolidated specification information and the extended information. The server calls a parametric modeling engine and passes parameter values such as width, depth, height, backrest angle, leg height, cushion thickness, and material types. The modeling engine constructs a geometric model by executing rules that create and position primitives, extrude surfaces, and define joints. The server exports the resulting geometry as three-dimensional shape data, including vertices, faces, and material assignments, and outputs this three-dimensional shape data for transfer to the terminal.

### Step 16:

The terminal renders an updated three-dimensional preview of the customized product.

The terminal receives as input the three-dimensional shape data from the server. The terminal loads the geometry into the game engine's mesh and material components, instantiates a new product object in the scene, and replaces any previous version of the product visualization.

The terminal uses the GPU to rasterize the mesh under current lighting and camera settings, and outputs updated image frames to the head-mounted display. The user therefore sees a three-dimensional preview that reflects the latest specification and extended information.

### Step 17:

The user evaluates the preview and optionally requests further changes.

The user visually inspects the three-dimensional preview and provides as input additional verbal commands and gestures such as “Raise the backrest slightly” or “Change the legs to black.” The terminal acquires this input using the same audio and motion capture pipeline as before, generates new audio frames and provisional parameter changes, and sends these as output to the server. The server then repeats Steps 8 through 16, processing the new input to update specification information, emotional state, prompt sentence, extended information, and three-dimensional shape data.

### Step 18:

The user confirms a final configuration for purchase.

The user selects a purchase control in the user interface or issues a voice command indicating purchase. The terminal receives this confirmation as input and combines it with a reference to the current specification information and extended information. The terminal transmits a purchase confirmation message to the server as output.

### Step 19:

The server generates detailed design information for the confirmed product.

The server receives as input the purchase confirmation and the final specification and extended information. The server invokes a design generation module that converts parametric product data into detailed engineering data. The server calculates internal structure dimensions, joint locations, and material stacking parameters, and generates a set of detailed design records including component geometries, tolerances, and functional requirements. The server outputs detailed design information and stores it in a design database.

### Step 20:

The server creates a manufacturing process plan and initiates production.

The server receives as input the detailed design information. The server analyzes components and required operations to construct a list of manufacturing steps such as cutting, shaping, assembling, and inspecting. The server queries a manufacturing resource database for machine capabilities and availability and uses this input to assign operations to resources and schedule them over time. The server outputs a manufacturing process plan that includes operation identifiers, assigned equipment, and scheduled times, and sends this plan to a manufacturing execution system that controls physical equipment.

### Step 21:

The server tracks manufacturing and delivery status and notifies the user.

The server receives as input progress updates from the manufacturing execution system and tracking updates from a logistics system, indicating current manufacturing stages and shipping locations. The server transforms these raw updates into user-readable statuses such as “In production,” “Under inspection,” “Shipped,” and “Out for delivery.” The server outputs these statuses in notification messages, which the server sends to the terminal. The terminal receives the notifications and renders them in the virtual store interface, allowing the user to view real-time progress of the customized product.

### Step 22:

The server logs interaction data and updates models.

The server receives as input session-wide data including sequences of specification information states, emotional states, prompt sentences, generative AI responses, and final selection and satisfaction outcomes. The server writes this data into structured logs. At scheduled times, the server loads these logs as input to a learning module, which computes gradients of loss functions measuring errors in emotion estimation or suboptimal prompt choices. The server updates weights of the emotion estimation neural network and parameters of the prompt generation rules based on these gradients. The server outputs updated model parameters that are stored and used for future sessions, thereby improving prediction accuracy and interaction efficiency over time.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

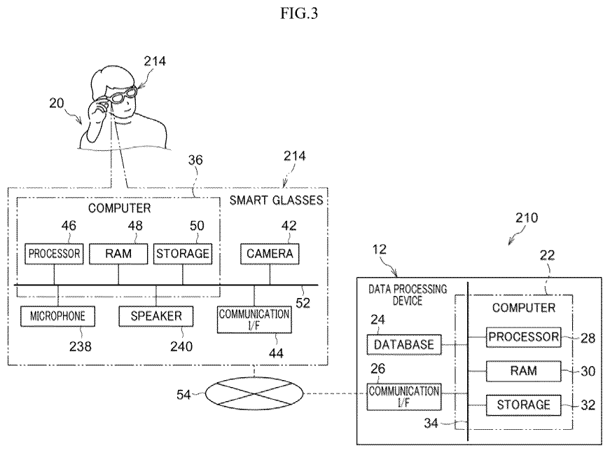

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

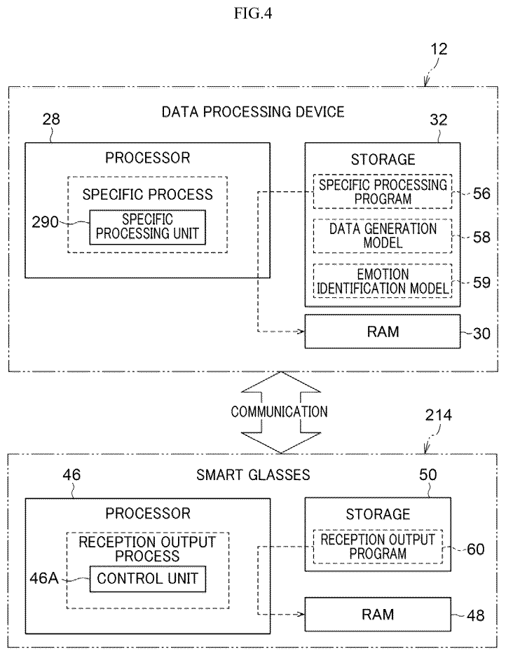

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

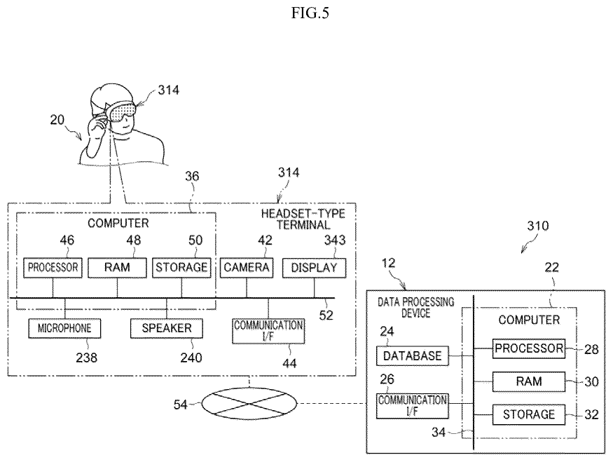

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

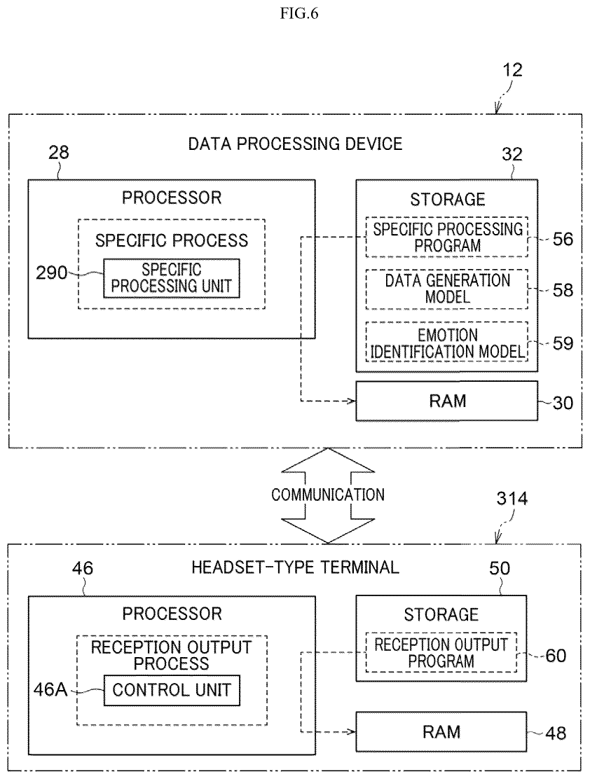

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

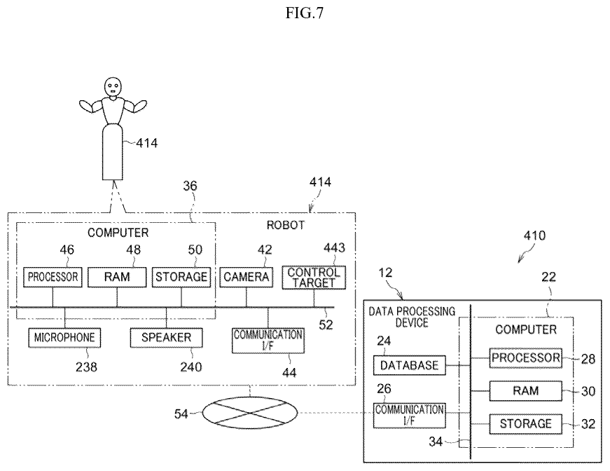

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

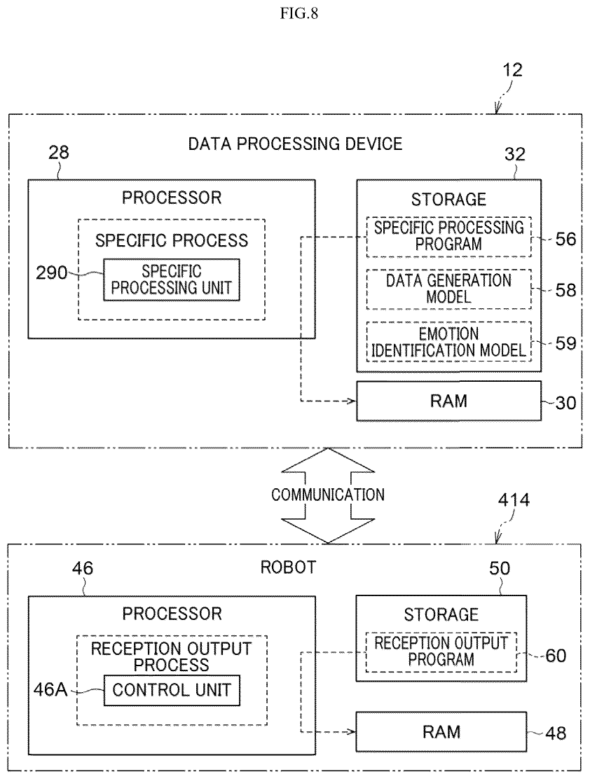

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

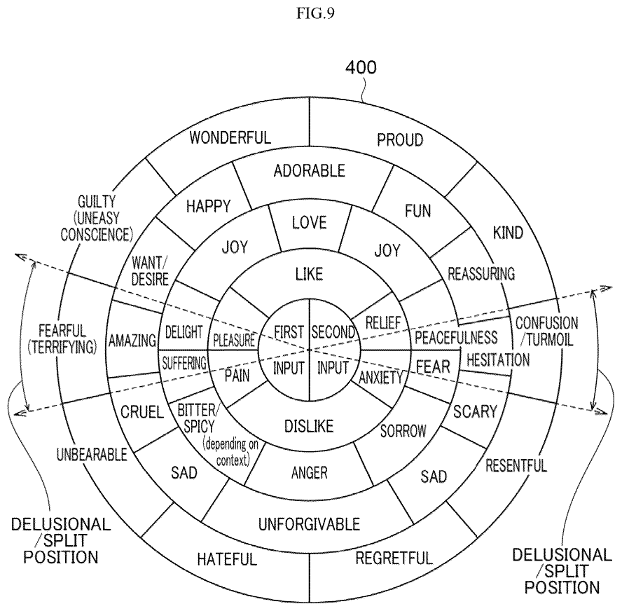

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

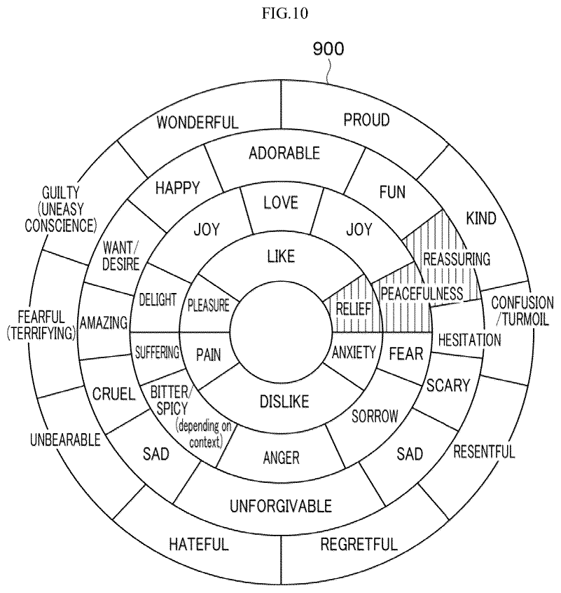

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, from a terminal operated by a user, a prompt sentence and other specification information representing at least a product category, a shape, a color, a dimension, a material, and a functional requirement, and convert the prompt sentence and the other specification information into structured specification data,
invoke a generative AI model using the prompt sentence and the structured specification data as input, infer, based on an output of the generative AI model, at least one missing item or recommended parameter included in the specification of a product, and integrate the inferred item or parameter into the structured specification data to generate extended specification data,
generate, based on the extended specification data, three-dimensional shape data and material data, and generate three-dimensional display data that is updatable in response to a change of a viewpoint with respect to the three-dimensional shape data,
transmit the three-dimensional display data to the terminal, receive, from the terminal, an instruction for modifying the specification information, and, in response to the instruction, update the structured specification data and re-generate the three-dimensional display data to provide an interactive three-dimensional preview to the user,
control design software based on the extended specification data and the three-dimensional shape data to automatically generate design data including detailed shape and dimension parameters and a component configuration including a list of components required for manufacturing the product,
generate, based on the design data and the component configuration, process planning data including a selection of a type of production equipment and an order of processes, generate work instruction data and a process schedule, and dynamically update the process schedule based on production progress information received from a production facility,
control, based on the work instruction data, at least one piece of production equipment to perform machining, assembly, and finishing of materials so as to manufacture the product, and generate, based on completion information of the product, delivery information including at least a delivery route, a delivery means, and tracking information, and provide the delivery information to the terminal.

### (Supplementary 2)

The system according to supplementary 1,
wherein the processor is configured to
acquire, from the terminal, specification information input by the user via a display device enabling touch operation, a voice input device, and an image acquisition device, the specification information including at least the shape, the color, the dimension, the material, and the functional requirement, and cause the terminal to display the three-dimensional display data generated by the processor, and, in response to an operation of the user on the terminal, sequentially update the structured specification data used for generation of the three-dimensional display data.

### (Supplementary 3)

The system according to supplementary 1,
wherein the processor is configured to
generate, from the prompt sentence and the structured specification data, an input text for the generative AI model, receive from the generative AI model an output including at least one recommended dimension parameter, structural parameter, and functional parameter, convert the output into a format usable by the design data and the process planning data, and integrate the converted output into the extended specification data.

### Application Example 1

### (Supplementary 1)

A system comprising a processor,
wherein the processor is configured to
receive, from a consumer, a natural language prompt sentence and motion information in a virtual space, and to extract and update a product specification based on the prompt sentence and the motion information,
generate, based on the product specification, a prompt sentence including attribute information of a product, the attribute information including at least a product category, an intended use, a dimension, a color, and a material, input the generated prompt sentence to a generative AI model, acquire from the generative AI model at least one of a complementary product specification or design candidate information, and expand and fix the product specification based on an acquisition result,
generate, based on the fixed product specification, three-dimensional model data for a virtual reality output device, perform at least one of dimension change, shape deformation, and texture assignment of material and color to the three-dimensional model data, and provide, to the virtual reality output device, a three-dimensional preview that is rotatable, scalable, and placeable in the virtual space in real time,
generate, based on the fixed product specification and three-dimensional preview information, detailed design data and parts list data that satisfy internal structure, component configuration, and functional requirements of the product, with reference to design rule information and constraint information,
generate, based on the detailed design data and the parts list data and with reference to facility information and load information, manufacturing process plan data including at least an order of machining, assembly, and inspection processes, a production facility and an operator assigned to each process, and start and end times of each process, and perform load balancing of a manufacturing line and mitigation of bottlenecks,
distribute, in accordance with the manufacturing process plan data, a machining program and control parameters to production facilities, control at least cutting, forming, machining, assembly, and inspection of materials, collect manufacturing state information, and update the manufacturing process plan data as needed, and
generate, for a product whose manufacturing has been completed, shipment information based on packaging information and transportation conditions, select a transportation route and a transportation means, and notify delivery status information to a consumer terminal.

### (Supplementary 2)

The system according to supplementary 1,
wherein the processor is configured to
provide a virtual reality interface that allows the consumer to input shape parameters and dimension parameters by performing, using a head-mounted display device and an operation device, an action of pointing to or gripping a product display object in the virtual space, and to input, using a voice input device, specifications including at least a color, a material, and a style in natural language, supply the motion information and voice information obtained from the virtual reality interface to the processing for extraction and update of the product specification and the processing for generation and expansion of the product specification, and cause the three-dimensional preview to be interactively updated in real time on the virtual reality interface so that the consumer can iteratively modify the specification while checking the three-dimensional preview.

### (Supplementary 3)

The system according to supplementary 1,
wherein the processor is configured to
generate, based on the natural language prompt sentence acquired from the consumer and the product specification extracted by the processor, a standardized prompt sentence including at least a product category, an intended use, a dimension, a color, a material, and a functional requirement, using a prompt template and an attribute mapping rule, input the standardized prompt sentence to the generative AI model, acquire from the generative AI model at least one of a design proposal, a structural proposal, or a completion result of a missing parameter, and use an acquisition result as input data for the detailed design.

### Example 2

### (Supplementary 1)

A system comprising a processor,
wherein the processor is configured to
acquire, from a terminal operated by a user, specification information of a product and instruction information in a natural language as input information via an input interface, estimate an emotion state of the user based on facial image information, audio information, and operation-history information transmitted from the terminal by executing an emotion recognition process using an image analysis function, an audio analysis function, and an operation-pattern analysis function,
construct a generation prompt sentence based on the specification information and the emotion state, input the generation prompt sentence to a generative AI model that generates product specification candidate information from the generation prompt sentence, and obtain a plurality of pieces of product specification candidate information as output from the generative AI model,
generate three-dimensional shape data and display data of the product for each of the plurality of pieces of product specification candidate information by using a three-dimensional modeling function based on shape information and appearance information included in the plurality of pieces of product specification candidate information, and provide a three-dimensional preview based on the three-dimensional shape data and the display data to the terminal via a communication interface,
dynamically control contents of the generation prompt sentence and a display mode of a user interface on the terminal, including a screen configuration, a number of options to be presented, a detail level of explanatory information, and an arrangement of operation components, based on the emotion state and the plurality of pieces of product specification candidate information,
acquire final product specification information confirmed by the user based on the three-dimensional preview, and generate detailed design information and part information based on the final product specification information by executing a design process,
generate manufacturing process plan information including an operation sequence, equipment to be used, and required time by executing a process planning process based on the detailed design information, the part information, and manufacturing facility information,
control manufacturing equipment according to the manufacturing process plan information, manage manufacturing progress information related to production of the product by executing a manufacturing management process,
and generate delivery status information based on shipping information and delivery route information of the product and provide the delivery status information to the terminal via the communication interface by executing a delivery management process.

### (Supplementary 2)

The system according to supplementary 1,
wherein the processor is configured to
limit, when a degree of indecision or a degree of burden of the user estimated by the emotion recognition process is equal to or greater than a predetermined threshold, a number of product specification candidate information pieces generated by the generative AI model to be equal to or less than a predetermined number and control the display mode of the user interface such that only representative product specification candidate information pieces are presented as the three-dimensional preview, and reduce, when a degree of satisfaction of the user estimated by the emotion recognition process is equal to or greater than the predetermined threshold, the number of product specification candidate information pieces to be presented while controlling the display mode of the user interface such that an input component for confirming the final product specification information is visually emphasized.

### (Supplementary 3)

The system according to supplementary 1,
wherein the processor is configured to
generate the detailed design information and the part information by inputting a design prompt sentence, which is constructed based on the final product specification information, to the generative AI model, generate the manufacturing process plan information including the operation sequence, the equipment to be used, and the required time by executing the process planning process based on the detailed design information and the part information, and
execute the manufacturing management process according to the manufacturing process plan information to perform control instructions to the manufacturing equipment, acquisition of the manufacturing progress information, and management of shipping preparation.

### Application Example 2

### (Supplementary 1)

A system comprising a processor,
wherein the processor is configured to
acquire instruction information including a natural language input from a consumer, and generate or update specification information relating to a product based on the instruction information,
acquire user state data including at least one of voice data, expression data, gaze data, behavior history data, and biometric data of the consumer, and estimate an emotional state of the consumer as a numerical index or a category based on the user state data,
automatically generate a prompt sentence including information relating to product classification, specification conditions, constraint conditions, and the emotional state based on the specification information and the emotional state, input the prompt sentence to a generative AI model, and acquire extended information relating to the product from the generative AI model,
generate three-dimensional shape data of an appearance of the product based on the specification information and the extended information, and generate a three-dimensional preview based on the three-dimensional shape data,
automatically create detailed design information including structural parameters, member configuration, dimensions, tolerances, and functional requirements of the product based on the specification information and the extended information,
automatically generate a manufacturing process plan including allocation of manufacturing equipment and workers, contents of operations in each process, an operation sequence, and a required time based on the detailed design information,
control manufacturing equipment in accordance with the manufacturing process plan to manufacture the product,
cause the manufactured product to be transported to a delivery destination,
dynamically change, based on the emotional state and the specification information, at least one of a display mode of a user interface, guidance content, and a display range of customization items in a virtual space or on a display apparatus,
acquire an execution status of the manufacturing process plan and a delivery status of the product, and notify the consumer of the execution status and the delivery status, and record at least the specification information, the emotional state, the prompt sentence, an output result of the generative AI model, and a final selection result of the consumer, and update parameters of an emotion estimation process and a prompt generation process based on a record of the information.

### (Supplementary 2)

The system according to supplementary 1,
wherein the processor is configured to
cause a head-mounted display, an input device, and a voice input/output device to provide access for the consumer to a store display region in the virtual space, cause the consumer to select a product object arranged in the store display region, enable the consumer to intuitively change the specification information including at least color, shape, dimensions, material, and usage by using a voice input and a motion input, update and display in real time the three-dimensional preview generated based on the specification information and the extended information, and automatically switch, in accordance with the emotional state, at least one of a type of customization item to be displayed and a guidance method.

### (Supplementary 3)

The system according to supplementary 1,
wherein the processor is configured to
generate, as the detailed design information, a detailed design drawing and part configuration information in which an internal structure, functional elements, and reliability conditions of the product are taken into account based on the specification information and the extended information, automatically optimize, as the manufacturing process plan, at least one of a layout of a manufacturing line or a work cell, equipment allocation, and a schedule based on the detailed design information, execute control that allows monitoring of manufacturing conditions based on the manufacturing process plan and, when necessary, changing at least one of processing conditions or work instructions, and present a result of the control to the consumer via progress notification.

What is claimed is:

1. A system comprising:
circuitry configured to:
receive, via a communication interface operating over a packet-switched network, a prompt sentence and specification information from a terminal device, and convert the prompt sentence and the specification information into structured specification data;
transmit the structured specification data as input to a generative information processing model via the communication interface, receive from the generative information processing model output information comprising at least one inferred parameter, and integrate the output information into the structured specification data to generate extended specification data;
generate, based on the extended specification data, three-dimensional shape data and material data, and generate three-dimensional display data that is updatable in response to a change of a viewpoint with respect to the three-dimensional shape data;
transmit the three-dimensional display data to the terminal device via the packet-switched network, receive from the terminal device a modification instruction, and in response to the modification instruction, update the structured specification data and regenerate the three-dimensional display data; and
generate, based on the extended specification data and the three-dimensional shape data, design data comprising detailed shape and dimension parameters and a component configuration.

2. The system according to claim 1, wherein the specification information comprises at least a product category, a shape, a color, a dimension, a material, and a functional requirement input by a user via the terminal device.

3. The system according to claim 2, wherein the output information received from the generative information processing model comprises at least one of a recommended dimension parameter, a structural parameter, and a functional parameter, and the circuitry converts the output information into a format usable by the design data and integrates the converted output information into the extended specification data.

4. The system according to claim 3, wherein the three-dimensional display data comprises three-dimensional model data for display on the terminal device, and the circuitry performs at least one of dimension change, shape deformation, and texture assignment of material and color to the three-dimensional shape data to provide a three-dimensional preview that is rotatable, scalable, and viewable from a plurality of viewpoints.

5. The system according to claim 4, wherein the circuitry is further configured to receive from the terminal device a plurality of sequential modification instructions, and for each modification instruction, update the structured specification data and regenerate the three-dimensional display data to provide an interactive preview session to the user.

6. The system according to claim 5, wherein the design data further comprises a parts list comprising a list of components required based on the extended specification data, and the circuitry generates the design data with reference to design rule information and constraint information.

7. The system according to claim 6, wherein the circuitry is further configured to generate, based on the design data and the parts list, process planning data comprising a selection of a type of production equipment, an order of processes, and start and end times of each process.

8. The system according to claim 7, wherein the circuitry is further configured to generate work instruction data based on the process planning data, distribute the work instruction data to production equipment via the packet-switched network, and dynamically update the process planning data based on progress information received from the production equipment.

9. The system according to claim 8, wherein the circuitry is further configured to control at least one piece of production equipment to perform machining, assembly, and finishing based on the work instruction data, and collect state information from the production equipment to update the process planning data as needed.

10. The system according to claim 9, wherein the circuitry is further configured to generate, upon completion of operations based on the process planning data, delivery information comprising at least a delivery route, a delivery means, and tracking information, and transmit the delivery information to the terminal device via the packet-switched network.

11. The system according to claim 1, wherein the circuitry is further configured to estimate an emotion state of a user based on at least one of facial image information, audio information, and operation-history information received from the terminal device by executing an emotion recognition process.

12. The system according to claim 11, wherein the circuitry is further configured to construct the prompt sentence based on the specification information and the estimated emotion state, and obtain from the generative information processing model a plurality of pieces of specification candidate information.

13. The system according to claim 12, wherein the circuitry is further configured to generate the three-dimensional display data for each of the plurality of pieces of specification candidate information, and provide a plurality of three-dimensional previews to the terminal device via the packet-switched network.

14. The system according to claim 13, wherein the circuitry is further configured to dynamically control a display mode of a user interface on the terminal device, including at least one of a screen configuration, a number of options to be presented, a detail level of explanatory information, and an arrangement of operation components, based on the estimated emotion state.

15. The system according to claim 14, wherein when a degree of indecision of the user estimated by the emotion recognition process is equal to or greater than a predetermined threshold, the circuitry limits a number of specification candidate information pieces generated by the generative information processing model to a predetermined number and controls the display mode such that only representative specification candidate information pieces are presented as the three-dimensional preview.

16. The system according to claim 1, wherein the circuitry is further configured to generate an input text for the generative information processing model from the prompt sentence and the structured specification data, and receive from the generative information processing model an output comprising at least one recommended dimension parameter, structural parameter, and functional parameter, and convert the output into a format usable by the design data.

17. The system according to claim 16, wherein the circuitry is further configured to perform load balancing of a production line based on the design data and facility information, generate a process schedule, and mitigate bottlenecks by dynamically reassigning operations among available production equipment.

18. A system comprising:
circuitry configured to:
receive, via a communication interface operating over a packet-switched network using a transport layer security protocol, a prompt sentence and specification information from a terminal device, the specification information comprising at least a product category, a shape, a color, a dimension, a material, and a functional requirement, and convert the prompt sentence and the specification information into structured specification data;
transmit the structured specification data as input to a generative information processing model via the communication interface, receive from the generative information processing model output information comprising at least one of a recommended dimension parameter, a structural parameter, and a functional parameter, and integrate the output information into the structured specification data to generate extended specification data;
generate, based on the extended specification data, three-dimensional shape data and material data, perform at least one of dimension change, shape deformation, and texture assignment of material and color to the three-dimensional shape data, and generate three-dimensional display data that is rotatable, scalable, and updatable in response to a change of a viewpoint;
transmit the three-dimensional display data to the terminal device via the packet-switched network, receive from the terminal device a plurality of sequential modification instructions, and for each modification instruction, update the structured specification data and regenerate the three-dimensional display data;
generate, based on the extended specification data and the three-dimensional shape data, design data comprising detailed shape and dimension parameters and a component configuration including a parts list, with reference to design rule information and constraint information;
generate, based on the design data and the parts list, process planning data comprising a selection of a type of production equipment, an order of processes, and start and end times of each process, and generate work instruction data based on the process planning data;
distribute the work instruction data to production equipment via the packet-switched network, collect state information from the production equipment, and dynamically update the process planning data based on the state information; and
generate, upon completion of operations, delivery information comprising at least a delivery route and tracking information, and transmit the delivery information to the terminal device via the packet-switched network.

19. The system according to claim 18, wherein the circuitry is further configured to estimate an emotion state of a user based on at least one of facial image information, audio information, and operation-history information received from the terminal device, construct the prompt sentence based on the specification information and the estimated emotion state, obtain from the generative information processing model a plurality of pieces of specification candidate information, and dynamically control a display mode of a user interface on the terminal device based on the estimated emotion state.

20. A method performed by circuitry of a system, the method comprising:
receiving, via a communication interface operating over a packet-switched network, a prompt sentence and specification information from a terminal device, and converting the prompt sentence and the specification information into structured specification data;
transmitting the structured specification data as input to a generative information processing model via the communication interface, receiving from the generative information processing model output information comprising at least one inferred parameter, and integrating the output information into the structured specification data to generate extended specification data;
generating, based on the extended specification data, three-dimensional shape data and material data, and generating three-dimensional display data that is updatable in response to a change of a viewpoint with respect to the three-dimensional shape data;
transmitting the three-dimensional display data to the terminal device via the packet-switched network, receiving from the terminal device a modification instruction, and in response to the modification instruction, updating the structured specification data and regenerating the three-dimensional display data; and
generating, based on the extended specification data and the three-dimensional shape data, design data comprising detailed shape and dimension parameters and a component configuration.
